(19) United States
(12) Patent Application Publication
(10) Pub. No.: US 2026/0211107 A1
(43) Pub. Date: Jul. 23, 2026

(54) MACHINE-LEARNING-BASED PROCESSING OF RADAR DATA FOR ENHANCED TARGETS DETECTION

(71) Applicant: Teraki GmbH, Berlin (DE)

(72) Inventors: Daniel Richart, Berlin (DE); Ernesto Horne, Berlin (DE); Deniz Kumlu, Istanbul (TR)

(73) Assignee: Teraki GmbH, Berlin (DE)

(21) Appl. No.: 19/032,820

(22) Filed: Jan. 21, 2025

(51) Int. Cl. G01S 13/931; B60W 30/09; G01S 7/41

(52) U.S. Cl. CPC G01S 13/931; B60W 30/09; G01S 7/417; B60W 2420/408

(57) ABSTRACT

A combination of processing techniques including ML-based techniques are used to process radar data to improve detection of targets from the radar data, especially for detecting valid targets in noisy environments and isolating valid targets from noise, clutter, and interference. By processing an input RD map using an ML model and then by performing denormalization on the output of the ML model, the values associated with the pixels in the input RD map are stretched such that the distance between the noise floor and valid target peaks in the input RD map is increased. This stretching accentuates the contrast between the noise and target signals in the RD map data, improving the detectability of weak targets in challenging environments by making weak and distant targets more distinguishable during the target detection phase.

### FIELD

The present disclosure relates to using machine learning (ML) models to enhance the detection of targets from radar data captured by one or more radar sensors such as via peak detection with respect to a radar-doppler (RD) map. More specifically, a combination of processing techniques including ML-based techniques are used to process radar data to improve detection of targets from the radar data, especially for detecting valid targets in noisy environments and isolating valid targets from noise, clutter, and interference.

### BACKGROUND

Radar technologies have been widely used to detect targets since World War II. More recently, with an increasing number of vehicles being equipped with radars, the automotive industry has seen a rapid increase in the use of radars for various driver-assist technologies. For example, the data captured by radars is used, such as by transitioning a range-doppler (RD) map to a point cloud representation, for detecting and informing the driver about targets in a dynamically changing traffic environment in the vicinity of the vehicle. The radar data, such as in the form of Range-Doppler (RD) maps, is processed to identify targets in the vicinity of the vehicle. An RD map is essentially a two-dimensional space where the range (distance from the radar) and velocity (via Doppler shift) of detected targets are mapped. The targets can include objects such as other vehicles in the environment, humans, animals, buildings, trees, signs, rocks or other inanimate objects, and others.

The ability to accurately detect targets in a traffic environment from radar data, such as RD maps, is especially critical for enabling autonomous driving capabilities in vehicles. An autonomous vehicle is configured to automatically make critical decisions based upon the targets detected from the RD maps. However, detecting targets from RD maps is a technically challenging problem. It is difficult to isolate valid targets, such as weak or low signal-to-noise (SNR) targets (e.g., pedestrians, cyclists, distant targets, etc.), from noise, clutter, and interference in the radar data. Additionally, the detection has to be performed in near real time in a dynamically changing environment to enable the vehicle to make quick decisions for maintaining the safety of the driver and passengers in the car and also of humans and other objects in the vicinity of the vehicle and for avoiding a collision.

### SUMMARY

The present disclosure relates to using machine learning (ML) models to enhance the detection of targets from radar data captured by one or more radar sensors. More specifically, a combination of processing techniques including ML-based techniques are used to process radar data to improve detection of targets from the radar data, especially for detecting valid targets in noisy environments and isolating valid targets from noise, clutter, and interference.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure. The computer program and instructions may be stored on a non-transitory storage medium. The features disclosed in each embodiment can be combined in a relevant manner.

A method can include receiving a radar-based map of an environment surrounding a vehicle. The radar-based map can include a set of pixels, and each pixel of the set of pixels can have an associated value from a range of values. The method can include generating an intermediate map from the radar-based map, and the intermediate map can include a set of pixels corresponding to the set of pixels in the radar-based map. Generating the intermediate map can include generating a set of values for the set of pixels in the intermediate map based upon values of the corresponding pixels in the radar-based map. Generating the set of pixels values for the set of pixels in the intermediate map can include for each pixel of a subset of pixels of the set of pixels in the intermediate map, generating a value for the pixel that is greater than or lower than a value associated with the corresponding pixel in the radar-based map. The method can include generating a binary map based on the intermediate map. The binary map can include a set of pixels corresponding to the set of pixels in the intermediate map, and generating the binary map can include, for each pixel in the set of pixels of the binary map, computing a value for the pixel to a first value or a second value based upon a value of the corresponding pixel in the intermediate map. The method can include outputting the binary map. The binary map can include information usable for identifying one or more targets in the environment.

In some embodiments, generating the intermediate map can include using a machine-learning (ML) model to generate a first map from the radar-based map. The first map can include a set of pixels corresponding to the set of pixels in the radar-based map. Additionally or alternatively, using the ML model can include generating a set of values for the set of pixels in the first map based upon values of the corresponding pixels in the radar-based map. Additionally or alternatively, generating the set of pixels values for the set of pixels in the first map can include, for each pixel of a subset of pixels of the set of pixels in the first map, generating a value for the pixel that is greater than or lower than a value associated with the corresponding pixel in the radar-based map.

In some embodiments, generating the intermediate map further includes generating the intermediate map from the first map by performing a de-normalization operation on the first map.

In some embodiments, the method can additionally include identifying one or more targets in the environment using the binary map.

In some embodiments, generating the binary map based upon the intermediate map can include applying a constant false alarm rate (CFAR) algorithm to the intermediate map to generate the binary map.

In some embodiments, the first value is zero and the second value is one.

In some embodiments, generating the intermediate map can include using a trained machine-learning model that is a trained convolutional neural network (CNN) including (i) an input layer, (ii) a first convolution layer, (iii) a second convolution layer, and (iv) an output convolution layer. A number of model parameters for the trained CNN is less than 100.

In some embodiments, the output convolution layer can include a sigmoid activation function that generates a sigmoid output, and the method can additionally include applying an adaptive threshold value to the intermediate map to determine the first value and/or the second value for the corresponding pixel.

In some embodiments, generating the binary map can include, for each pixel of the subset of pixels of the set of pixels in the intermediate map: (i) generating and associating the first value with the pixel if a value associated with the corresponding pixel in the intermediate map is above a threshold; and (ii) generating and associating the second value with the pixel if a value associated with the corresponding pixel in the intermediate map is less than or equal to the threshold. Additionally or alternatively, the threshold is a hard threshold or an adaptive threshold.

In some embodiments, the method can additionally include training a machine-learning model to generate the trained machine-learning model. Training the machine-learning model can include (i) detecting an environmental map using a set of sensors in which the set of sensors includes more than one type of position sensor, (ii) generating a ground truth map based on the environmental map and by annotating, for each target indicated by the environmental map, (i) a velocity, (ii) a range, and (iii) a position of the target, and (iii) inputting the environmental map and the ground truth map into the machine-learning model to train the machine-learning model.

In some embodiments, the radar-based map is used to generate a point cloud that represents an environment surrounding a vehicle in motion. Additionally or alternatively, the method can additionally include (i) detecting a first target in the environment using the binary map and the point cloud, and (ii) responsive to detecting the first target, altering, based on spatial information included in the point cloud, a trajectory of motion of the vehicle to avoid a collision with the first target.

### BRIEF DESCRIPTION OF THE DRAWINGS

FIG. 1 is a diagram illustrating an environment in which a machine-learning model can be used for generating a binary map of targets in the environment according to an embodiment of the present invention.

FIG. 2 is a diagram of a machine-learning system for generating a binary map of targets in an environment according to an embodiment of the present invention.

FIG. 3 is a set of radar-based maps that includes a binary map of targets in an environment according to an embodiment of the present invention.

FIG. 4 is a diagram of a machine-learning model of a machine-learning system for generating a binary map of targets in an environment according to an embodiment of the present invention.

FIG. 5 is a diagram of a data flow for generating a ground truth for a training process for a machine-learning model of a machine-learning system for generating a binary map of targets in an environment according to an embodiment of the present invention.

FIG. 6 is a flowchart of a process for generating a binary map of targets in the environment according to an embodiment of the present invention.

FIG. 7 is a flowchart of a process for generating a ground truth map for training a machine-learning model a machine-learning system for generating a binary map of targets in an environment according to an embodiment of the present invention.

FIG. 8 is a flowchart of a process for training a machine-learning model a machine-learning system for generating a binary map of targets in an environment according to an embodiment of the present invention.

FIG. 9 is a simplified block diagram illustrating components of a radar signal processing system according to an embodiment of the present invention.

The foregoing, together with other features and embodiments will become more apparent upon referring to the following specification, claims, and accompanying drawings.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to using machine learning (ML) models to enhance the detection of targets from radar data captured by one or more radar sensors. More specifically, a combination of processing techniques including ML-based techniques are used to process radar data to improve detection of targets from the radar data, especially for detecting valid targets in noisy environments and isolating valid targets from noise, clutter, and interference. The radar data may be in the form of Range-Doppler (RD) maps. In some embodiments, an RD map can be or include a complex-value map in the dimensions of the range and doppler domain. The input for a peak detector can include an integrated RD map. The integrated RD map can be computed by adding the RD maps corresponding to multiple antenna elements of the radar such as virtual channels. The integration can be done in various suitable ways. The integrated RD map can include positive values. The input into an ML-based model can include the integrated RD map.

The radar data that is processed may represent the environment around a vehicle and the enhanced techniques describe herein may be used to better detect targets in the vehicle's environment and take responsive actions, such as autonomously changing a trajectory of motion of the vehicle, as needed. The detection of the targets on the RD map may be related to a large or the largest decrease of data size. In some embodiments, the number of detections in the RD map is less than 5% of the full dimension of the RD map.

A combination of ML-based processing and denormalization processing is used to generate an intermediate RD map from the input RD map representing radar data captured by one or more radar sensors for an environment. In certain implementations, as part of the processing pipeline, an input RD map is processed by a machine-learning (ML) model (e.g., a Convolutional Neural Network-based model), which has been trained using deep learning techniques to identify potential targets in the input RD map and generate a map in which the distance between the noise floor and target peaks in the input RD map are stretched. The stretching makes weak and distant targets more distinguishable during the target detection phase. The ML model is trained specifically to detect peaks in noisy environments, where traditional methods might fail to differentiate between noise and valid targets. In some embodiments, the machine learning (ML) model can assign a confidence score between 0 and 1 for the peaks in the RD map. A confidence score close to 1 indicates a strong likelihood that the detected peak corresponds to a valid target, whereas a score close to 0 suggests that the detected peak is not a target such as likely being noise.

The output of the ML model is then denormalized, which further stretches the gap between noise and peaks in the radar data, further increasing the visibility of weak targets in the target detection phase and makes it easier to accurately identify target peaks, especially those that are close to the noise floor. In certain implementations, denormalization is done such that the output of the denormalization retains the dynamic range of the original input RD map. This scaling process accentuates the contrast between the noise and target signals, improving the detectability of weak targets in challenging environments. In some embodiments, denormalization can include a process of mapping the confidence scores generated by the ML-based model to the power map to calculate radar attributes such as signal-to-noise ratio (SNR), radar cross section (RCS), energy, and detector margin. This mapping can enable a quantitative evaluation of the detected peaks. The denormalization process may reflect an improved estimation of radar attributes over other techniques.

The output of the denormalization processing includes an intermediate map that includes pixels corresponding to pixels in the input RD map in which, as a result of the processing by the ML model and the denormalization, the values associated with the pixels in the intermediate map may different or the same as the values associated with the pixels in the input RD map. The intermediate map is then used to generate a binary map that includes pixels corresponding to the input RD map. In certain implementations, each pixel in the binary map is classified as either a target (represented by a first value associated with the pixel, e.g., 1) or not a target, such as noise, represented by a second value associated with the pixel, e.g., 0). As part of generating the binary map, a pixel value, which is the first value or the second value, is computed and associated with each pixel in the binary map based upon a value of a corresponding pixel in the intermediate map. This binary map can then be used for further radar processes, such as classification, Direction of Arrival (DoA) estimation, tracking, etc.

In some embodiments, the intermediate map may serve as a basis for generating a binary map that identifies and isolates relevant targets from the input map. In the binary map, each pixel is classified as either a target or non-target such as noise. For example, (i) pixels corresponding to targets are assigned a first value, such as 1, and pixels corresponding to noise or non-target regions are assigned a second value such as 0. To improve target separation and to enhance detection accuracy, the distance between noise values and target values can be stretched. This step increases the contrast between potential targets and background noise, making it easier to distinguish meaningful peaks in the RD map.

Following this enhancement, a variational thresholding approach can be applied, which adapts the threshold levels based on range information. The SNR of targets decreases with increasing distance from the radar. That is, the farther a target is, the weaker its reflected signal becomes relative to noise. To address this SNR attenuation, a range-based hard thresholding technique can be applied. The range-based hard thresholding technique involves defining and applying multiple threshold values corresponding to different range bins. Each threshold is adjusted to account for the expected SNR drop-off at the corresponding specific range. As a result, the thresholding process becomes more robust, allowing weaker, distant targets to be detected while reducing the likelihood of misclassifying noise as a target. This combination of value stretching and range-based thresholding significantly improves target detection performance, especially for low-SNR targets such as pedestrians, cyclists, or objects at long distances. It ensures that the system maintains a balance between sensitivity to weak signals and resistance to noise, enhancing overall radar detection reliability.

In some embodiments, the binary map can be generated based on the intermediate map using a hard threshold, using a range-based threshold, or using an adaptive threshold. The hard threshold may be preselected. Examples of a preselected hard threshold can include about 10 dB, about 12 dB, about 14 dB, about 16 dB, about 18 dB, about 20 dB, etc. The range-based threshold can involve applying variational, range-based thresholding to an output such as from a machine-learning model or combined machine-learning model. The adaptive threshold may be applied by applying a constant false alarm rate (CFAR) algorithm to the intermediate map. The CFAR algorithm may involve applying a dynamic threshold, which may differ for different pixels and/or different intermediate maps, as the adaptive threshold. An output of applying the hard threshold or the adaptive threshold includes the binary map. For example, after applying the hard threshold or the adaptive threshold, a value of the corresponding pixel can be one of two values such as 0 (not a target) or 1 (target).

In some embodiments, the signal-to-noise Ratio (SNR) may be a parameter in radar signal processing that measures the strength of a target signal relative to the surrounding noise. A high SNR means that the target signal is easily distinguishable from noise, while a low SNR implies that the target might be obscured by noise, making detection challenging. In a radar system, SNR is inversely related to range. This means that as the distance (or range) from the radar increases, the SNR typically decreases. This phenomenon occurs because the radar signal spreads out as it propagates through space and also experiences attenuation due to atmospheric factors. As a result, by the time the signal returns to the radar from a distant target, its strength is significantly reduced compared to signals from closer targets. The noise floor of a radar system, representing the ambient noise level, may remain constant across all ranges. However, in practical scenarios, particularly in FMCW (Frequency-Modulated Continuous Wave) radar systems, environmental clutter and system-specific factors can result in a noise floor that is not uniform across ranges. This variability is especially pronounced at shorter distances.

In some embodiments, to mitigate the challenges of range-dependent SNR and ensure robust detection of weak and distant targets, range-dependent variational thresholding can be used. This approach involves dynamically adjusting the detection threshold based on the range bins in the range-Doppler map. Range-dependent thresholding takes advantage of the fact that the SNR of a target decreases predictably with range. By lowering the detection threshold for distant range bins, the radar system can compensate for the reduced SNR at greater distances. This adaptive approach ensures that weak signals from distant targets are not overlooked simply because they fall below a uniform threshold. ML-CFAR models suppress the noise level effectively, creating a cleaner baseline for detection. This suppression means that the noise floor across the range bins is relatively uniform, and the variation in signal strength is primarily due to the target's range. By applying a variational threshold that adjusts with range, the system effectively balances sensitivity and specificity, maintaining high detection performance without increasing false alarms. Range-dependent thresholding not only improves the detection of weak and distant targets but also provides a more accurate representation of targets across the entire RD map. This balanced detection ensures that targets, regardless of their range, are represented with comparable fidelity. As a result, the radar system maintains a consistent detection capability, improving overall performance in challenging scenarios, such as detecting small or low-reflectivity targets at long distances. To address the range-dependent SNR variations, the detection threshold can be modeled as a function of range bins. This approach involves analyzing the radar's RD map to identify how SNR decreases across range bins and adjusting the threshold dynamically.

In some embodiments, and once the range-dependent threshold model is established, the threshold values can be optimized for each range bin. This involves fine-tuning the thresholds to balance sensitivity (detecting weak targets) and specificity (reducing false alarms). The process can involve data analysis, threshold optimization, and iterative refinement. The radar data can be analyzed to map the typical SNR distribution across range bins. Regions can be identified where weak targets are likely to appear and where clutter effects dominate. Lower thresholds can be set for distant range bins in which targets have reduced SNR. Higher thresholds can be set in shorter ranges to suppress clutter and noise spikes. The optimized thresholds can be tested against a variety of scenarios, including different environmental conditions and target profiles. Thresholds can be adjusted to maximize detection performance while maintaining a low false alarm rate. In some embodiments, a goal of modeling and optimizing range-dependent thresholds may include improving the accuracy and reliability of peak reporting. Peaks in a radar's RD map correspond to detected targets, and their prominence (or detectability) is influenced by the applied threshold.

Various different types of targets can be detected from the binary map representing an environment. A target can be an object that physically exists in the environment. For example, if the environment is an environment around a vehicle, examples of targets in that environment can include humans, cars, animals, structures, and/or any other objects that may be physically present in the environment. The one or more sensors that are used to generate the radar data can be positioned on the vehicle, in the environment around the vehicle, or a combination of on the vehicle and in the environment around the vehicle. In some embodiments, one or more actions may be performed upon detecting a target from the binary map. For example, for a vehicle in motion, upon detecting a target in the vehicle's environment, the trajectory of motion of the vehicles may be autonomously altered to possibly avoid a collision with the target. As another example, the speed of the vehicle may be reduced (or increased) to prevent a possible collision with the target. As yet another example, a warning regarding the presence of the target may be output to a driver of the vehicle. The warning may be output via an output device in the vehicle, for example, by displaying a warning on the vehicle's dashboard, by outputting an audio warning via the vehicle's audio output system, by a haptic feedback, and the like.

Deep learning-bases techniques are used to train the ML model (e.g., a CNN) to enable it to identify potentials targets in the RD map and stretch the corresponding values as appropriate. The stretching causes pixel values in the RD map data associated with identified targets to be stretched further away from noise data in the RD map. The ML model is thus trained to suppress the background noise from the signal to increase a signal-to-noise ratio (SNR) of the RD map. The target data can be further stretched from the noise data using denormalization to further increase the SNR of the RD map. Additionally, an output of the denormalization can have a threshold applied to it to transform the RD map into a binary map that includes only binary values for data. The binary values may be zero and one, though other suitable binary values are also possible. In some embodiments, rather than using a fixed threshold, a range-based variational thresholding approach can be applied. The range-based variational thresholding approach can adapt the threshold based on the range information in the RD map. Since the SNR decreases with distance, multiple threshold values can be defined for different range bins. This ensures that the thresholding process remains effective across varying distances, allowing the system to accurately classify targets while minimizing the inclusion of noise.

Vehicles (e.g., cars, trucks, motorcycles) are equipped with multiple radar sensors, in addition to other sensors, and the data collected by these sensors is used for various driver-assist technologies. For example, one or more radars sensors on a vehicle may capture radar data (e.g., in the form of an RD map) containing information about the physical environment in the vehicle's vicinity data. The RD maps may then be processed to identify targets in the vehicle's vicinity, serving as an intermediate step in the radar pipeline. While RD maps provide critical information about the range and velocity of detected targets, the point cloud data can be used for decision-making processes. Point cloud data, which includes additional spatial information such as azimuth and elevation (direction of arrival-DoA), enables the autonomous vehicle to make informed decisions on how to navigate safely around the identified targets. Despite being an intermediate output, RD maps facilitate accurate detection and laying the foundation for generating the point cloud data used in the later stages.

A radar generally involves a transmitter and a receiver (referred to together as a transceiver) of electromagnetic waves in the radar spectrum. The transmitter emits a wave, and this wave propagates freely in the air until it hits an object due to which the wave is at least partially reflected and the reflection is detected by the receiver. The object is then identified as a target through the physical characteristics of the reflected wave. The reflected wave can however include noise that can make it difficult to identify the target, especially the presence of the target at a particular location. Multiple waves can also interfere with each other further complicating the task of target detection. Accordingly, as indicated in the Background section, isolating valid targets from noise, clutter, and interference in the radar data is a technically challenging problem. This coupled with the requirement that the detection must be performed in near real time in a dynamically changing environment makes the detection even more challenging.

Existing systems and techniques for detecting targets from radar data (e.g., from RD maps) thus have several deficiencies. An RD map includes a two-dimensional space where the range (distance from the radar) and velocity (via Doppler shift) of detected targets are mapped. Current automative industry trends in radar signal processing largely focus on the continued use and refinement of traditional Constant False Alarm Rate (CFAR) models such as CA-CFAR (Cell-Averaging CFAR), OS-CFAR (Ordered Statistics CFAR), and their variations for target detections. These currently used CFAR models remain integral to modern radar systems due to their robustness and their ability to maintain a constant false alarm rate, which is important for ensuring reliable performance in dynamic environments.

However, more efficient detection is needed for several reasons:
(1) Signal-to-Noise Ratio (SNR): A radar's ability to differentiate between weak target signals and background noise and/or clutter depends on accurately identifying significant peaks in the RD map. As described in this disclosure, efficient detection techniques are described that ensure that even weak targets are properly isolated without being lost in the surrounding noise.
(2) Clutter Suppression: In many radar applications, such as automotive applications and aviation applications, clutter from buildings, ground reflections, or other large static objects can overwhelm the RD map. As described in this disclosure, enhanced target detection techniques are described that are able to suppress the clutter to focus on valid moving targets.
(3) Dynamic Environments: Scenarios in which target detection is to be performed include environments that change rapidly, such as moving vehicles or aircraft. Real-time detection at the RD level is essential in such environments. As described in this disclosure, efficient target detection algorithms are described that adapt to varying noise and interference patterns in the RD maps data while maintaining low latency, and ensuring timely responses.

The various embodiments described in this disclosure perform efficient RD-level target detection that enables the radar systems to process signals in real-time without overwhelming downstream stages that use the processed data, such as tracking and classification with false positives.

The various embodiments described in this disclosure may be implemented using software only, using hardware only, or using a combination of software and hardware. The software may be in the form of instructions or code that may be executed by one or more processing using such as processors, GPUs, etc. The software may be stored on a non-transitory computer-readable storage media. Some embodiments may be implemented by using a computer program product, comprising computer program/instructions which, when executed by one or more processors, cause the processors to perform any of the methods described in this disclosure.

In certain implementations, the signal-processing tasks described in this disclosure may be performed by a radar system that may be implemented using one or more Digital Signal Processors (DSPs). A DSP is a specialized hardware component that may be optimized for performing real-time signal processing tasks. For example, DSPs for processing radar data (referred to as “radar DSPs”) can handle the core computational load of a radar system, from Fast Fourier Transforms (FFTs) to beamforming and target detection. For target detection to be practical in radar DSPs, algorithms should be computationally lightweight for several reasons:
(a) Limited Processing Power: While DSPs are optimized for parallelized signal processing, they can be resource-constrained in terms of both compute and memory resources. Detection algorithms, such as those disclosed herein, can be efficient for running in real-time, ensuring that the radar system can process large volumes of incoming data without bottlenecking other radar operations such as tracking or beamforming.
(b) Real-Time Constraints: For DSPs deployed on autonomous vehicles, decisions have to be made with low extreme low latency, such as within milliseconds. The embodiments described in this disclosure use a lightweight detection algorithm that can ensure that the radar system meets real-time processing requirements. Additionally, if the target detection task is performed in a computationally expensive manner, the overall system is more expensive due to increased resource requirements and can suffer from high latency, leading to delayed responses. The embodiments described in this disclosure perform the target detection efficiently using a minimal set of resources while performing the task with low latency and very fast response times (e.g., within milliseconds).
(c) Low Power Consumption: The use cases for target detection, especially for automotive uses, is in power-constrained environments such as electrical vehicles. In such environments, power efficiency can be important. The various embodiments described in this disclosure use lightweight detection algorithms that consume less energy while providing high-quality detection, allowing for longer operational times without compromising performance.
   By using target detection techniques and algorithms that are efficient and lightweight, a radar DSP is able to perform other tasks efficiently and without restrictions, thereby ensuring that the entire radar data processing pipeline operates within desired real-time constraints.

Once targets are detected at the RD map level, information indicative of the detected targets can be used by a radar system for various downstream processing. These downstream uses or stages may include, for example, Direction of Arrival (DoA) estimation, classification, and tracking, and others. Efficient target detection can impact the performance of the processing performed in these stages.

Direction of Arrival (DoA) Estimation: DoA estimation involves determining the azimuth and elevation angles from which a signal originates. DoA estimation can be performed through techniques like beamforming or more advanced algorithms like MUSIC or ESPRIT. These algorithms need clean, reliable target data to produce accurate angular estimates. Efficient target detection using the various techniques described in this disclosure impact the following:
Reduced Data Load: Efficient target detection can ensure that only genuine targets are passed to the DoA estimation process. This minimizes the computational burden and can allow the radar system to allocate more processing power to angular resolution rather than filtering out false alarms.
Accuracy and Consistency: False or noisy detections can degrade DoA performance, resulting in incorrect angle estimations. Efficient detection at the RD level, as described herein, provides more accurate target localization, which can lead to better performance in DoA estimation.

Classification: After detecting targets, a radar system may classify the detected objects to distinguish between various types of targets or objects such as pedestrians, motorcycles, cars, buses, etc. The classification algorithm may use features derived from the RD map and possibly the angular information from DoA. Impacts from better target detection include:
Improved Classification Accuracy: When the input to the classification system is accurate and clutter-free, the classification algorithm can focus on real targets rather than noisy detections. This increases the reliability of the system in distinguishing between different types of objects, for example in examples in which machine-learning models are used for classification.
Reduced False Positives: Efficient detection at the RD level can prevent the classification stage from being overwhelmed by false positives, which may lead to incorrect object identification.

Tracking: Radar systems track the position, velocity, and sometimes the trajectory of detected objects over time using algorithms like Kalman filters or particle filters. The accuracy of tracking can depend on the quality of the initial target detection. In this context, impact from better target detection include:
Better Target Continuity: Efficient target detection can ensure that the tracking system receives consistent and reliable target data, which can reduce the likelihood of “track drops” (e.g., losing track of a valid target due to missed detections).
More Accurate Predictions: When the detection data is clean and reliable, tracking algorithms can make more accurate predictions about the target's future position. Efficient RD-level detection can ensure that the tracking system has high-quality input, improving the system's ability to track targets across multiple frames.

Efficient target detection using the techniques described in this disclosure can serve as a foundation for several downstream processes that use information indicative of the detected targets. In comparison, poor detection at the RD level, as seen in conventional systems, may result in a cascading effect and may reduce accuracy and reliability in later stages like DoA, classification, and tracking.

In high-density environments, such as urban areas or crowded airspaces, in which there are many potential targets and a lot of clutter, efficient target detection is even more critical. In a high-density environment, a radar system has to be able to detect multiple targets that are often closely spaced, and do so without introducing false alarms. Inefficient detection algorithms may fail to distinguish between overlapping or closely spaced targets, or the inefficient detection algorithms may generate too many false positives, which can overwhelm downstream processes like classification and tracking. Additionally, in high-density environments, clutter, such as reflections from buildings, terrain, or other large static objects, can fluctuate significantly. Efficient detection algorithms at the RD level can adapt dynamically to suppress clutter and prevent the clutter from being misidentified as a valid target. This can be helpful in several applications, such as autonomous driving, in which multiple objects (e.g., pedestrians, vehicles, roadside objects) are tracked in real time. Efficient detection, as described herein, can ensure that high-density target environments are manageable by reducing clutter and isolating real targets without overwhelming the system with false alarms.

Radar DSPs may be designed to handle a variety of tasks, from FFT processing to beamforming and target detection. Efficient target detection algorithms can ensure that the resources associated with radar DSPs are optimally utilized. For example, a radar DSP typically performs many parallel operations, and efficient detection algorithms described in this disclosure ensure that DSP resources are efficiently used and thus enabling more resources to be available for other important tasks like beamforming, DoA estimation, and tracking. Conventional inefficient detection algorithms consume too much processing power, leaving insufficient resources for the later stages. Many radar systems, especially those in mobile platforms, such as drones, autonomous vehicles, etc., may operate under strict memory and power constraints. The efficient target detection algorithms described in this disclosure can reduce memory overhead and power consumption by minimizing unnecessary computations and focusing only on the most relevant targets. By ensuring that target detection is lightweight and efficient, radar DSPs using the techniques described in this disclosure can balance the demands of real-time performance, memory usage, and power consumption and can ensure that the system operates effectively across the entire pipeline.

In some examples, an imaging radar and/or a cascaded radar systems can be used to enhance the quality of target detection in RD maps. These systems provide higher-resolution data that allow for more detailed target identification and enable better downstream processing. In certain used cases, the imaging radar can generate RD maps with much higher resolution than traditional radar systems and can capture finer details about the detected objects. This enables the imaging radar to detect smaller, more distant objects, and to distinguish between multiple targets that may be closely spaced (e.g., a pedestrian standing near a vehicle). This high-resolution data allows for more accurate classification and tracking in later stages. Cascaded radar systems, which can leverage multiple radar units to create larger virtual antenna arrays, can significantly improve the angular resolution, allowing a better DoA estimation, and allowing the radar to pinpoint the exact location of targets with greater precision, especially in multi-target environments such as dense traffic.

A machine-learning-based model can be used for peak detection and can integrate machine-learning (ML) and traditional constant false alarm rate (CFAR) algorithms. Some examples of CFAR algorithms can include cell averaging CFAR (CA-CFAR), ordered statistics CFAR (OS-CFAR), greatest of CFAR (GOCA-CFAR), and smallest of CFAR (SOCA-CFAR), though other suitable CFAR algorithms can be used. The machine-learning-based model may be a hybrid approach that significantly improves radar target detection performance compared with only using a CFAR algorithm. The machine-learning-based model can leverage the strengths of convolutional neural network (CNN)-based detection and can combine it with traditional CFAR techniques to refine the output and enhance target identification compared with other techniques. This multi-step process can ensure better detection performance by the machine-learning-based model, compared with other models, and can address shortcomings of standalone CFAR algorithms, especially in challenging environments in which weak targets can be masked by noise.

A range-doppler (RD) map can be generated, such as by one or more detectors on an autonomous vehicle or other suitable location, and passed through the machine-learning-based model. The machine-learning-based model can enhance the detection process by using deep learning to identify potential targets in the map. The CNN architecture of the machine-learning-based model may be designed to stretch the distance between the noise floor and target peaks, which makes weak and distant targets more distinguishable. The machine-learning-based model can be trained to detect peaks in noisy environments, where traditional methods might fail to differentiate between noise and valid targets.

Once the CNN has processed the RD map, the output can be denormalized. Denormalization can involve mapping the confidence scores generated by the ML-based model to the power map, which represents the original dynamic range of the input data. By restoring the values to their original scale, denormalization can ensure that the processed output aligns with the physical properties of the radar signal, thereby retaining the integrity of the data and helping to report radar attributes. Denormalization can make it easier for subsequent processing to accurately identify the target peaks, for example those that were otherwise close to the noise floor. Denormalization can be executed with respect to the input minimum and maximum intensity levels, ensuring that the output retains the dynamic range of the original RD map. This scaling process can accentuate the contrast between the noise and target signals and can improve the detectability of weak targets in challenging environments.

After denormalizing the output of the machine-learning-based model, a traditional CFAR algorithm with a predetermined threshold, which may be static or dynamic, can be applied. CFAR is employed here to provide a final binary output. This final step refines the detection process, ensuring that the output adheres to the system's false alarm rate requirements while taking advantage of the enhanced target signature provided by the machine-learning-based model. In some examples, the CFAR algorithm can evaluate each pixel in the denormalized output against the local noise estimate, using neighboring cells, and can apply the threshold to make the final decision on whether the pixel represents a target or noise. The use of CFAR with the threshold as a post-processing step can help eliminate spurious detections or false positives. The output of the CFAR algorithm can include a binary map in which each pixel is classified as either a target (1) or noise (0). This output can then be used for further radar processes, such as classification, DoA estimation, and tracking, etc.

Using the machine-learning-based model and the CFAR algorithm, along with denormalization and/or binary thresholding operations, can combine strengths of machine-learning and traditional techniques. For example, by using the machine-learning-based model for initial peak detection and denormalization, and then applying the CFAR algorithm, the accuracy and robustness of deep learning can be combined with the established reliability of CFAR techniques. The machine-learning-based model may excel at handling non-homogeneous noise environments and detecting weak targets, while the CFAR algorithm can ensure consistent performance with controlled false alarm rates without decreasing an associated threshold level. Additionally or alternatively, target detection at far distances can be improved over traditional techniques. The machine-learning-based model, which may be or include a CNN model, can be designed to maintain a high density of points per target even at far distances, while CFAR techniques alone may struggle due to weaker signal returns. The denormalization step can further enhance weak target peaks, compared to other processes not including denormalization steps, which can allow the subsequent CFAR algorithm to detect distant objects more reliably than other operations. Additionally or alternatively, false alarms can be reduced. One issue with traditional CFAR techniques is the potential for false alarms, especially in noisy environments. The machine-learning-based model and CFAR algorithm can be used to reduce false alarms by preprocessing the RD map and emphasizing true target signals, which can make it easier for the CFAR algorithm to accurately classify each pixel at a particular threshold such as 15 dB. The use of the 15 dB threshold may ensure that only significant target peaks are identified in the final binary output. Additionally or alternatively, parameter changes may be robust using the machine-learning-based model combined with the CFAR algorithm. The combined model may be robust to parameter changes because the deep learning layer, such as the CNN layer, may be able to adapt to varying noise levels and clutter, while the CFAR algorithm may provide a stable thresholding mechanism. The robustness may ensure that the radar system remains effective across different environmental conditions, noise levels, and target scenarios, etc.

The combined model, which may include the machine-learning-based model, the CFAR algorithm, the denormalization operation, etc., may involve or otherwise use one or more attributes. The attributes, such as intensity, noise floor, SNR, energy, radar cross section (RCS), and detector margin, etc., may be used in the radar industry to ensure comprehensive target characterization and performance validation. Radar manufacturers may rely on the attributes to optimize system performance, evaluate detection accuracy, and maintain compliance with evolving industry standards. The radar attributes can include intensity, noise floor, SNR, energy, RCS, and detector margin.

In radar systems, intensity may refer to the power of the reflected signal from a target, measured at the receiver. Intensity can help differentiate between strong and weak targets, with stronger returns generally coming from larger or more reflective objects. The machine-learning-based model, which may include a CNN-based peak detector, can identify the intensity peaks, and the CFAR algorithm can be used to accurately quantify the intensity peaks in relation to the surrounding noise.

The noise floor can represent an average background noise level in the RD map. The noise floor can include thermal noise, clutter, and/or any interference from other sources in the environment. The CFAR algorithm may dynamically estimate the local noise floor by examining the signal levels in the training cells surrounding a cell under test (CUT). This enables the radar system to adapt the detection threshold based on the varying noise levels, ensuring that targets are identified accurately even in noisy environments. The machine-learning-based model can improve the contrast between the noise floor and target peaks, and the CFAR can be used for measuring and reporting the precise noise floor values for further system analysis.

The SNR can be or include a measure of how much stronger the target's reflected signal is compared to the surrounding noise. A higher SNR value may indicate that the target is more easily distinguishable from noise, while a lower SNR may indicate that the target may be at least partially obscured by background noise. The CFAR algorithm can used in reporting SNR by comparing the intensity of the detected peak, such as from the machine-learning-based model, to the estimated noise floor. Reporting the SNR can directly affect the radar's ability to reliably detect and track weak targets, especially at long ranges or in cluttered environments.

Energy in the context of radar systems may refer to the total power returned from a target, measured over time and space. The energy may be measured in decibels relative to one watt (dBW). The energy can take into account not only the peak intensity of the signal but also the spread and duration of the return across multiple range and Doppler cells. The CFAR algorithm can allow the radar to report the overall energy of detected targets by integrating signal strength over a region of interest. This helps in assessing how much power was returned from the target and can be used for analyzing the radar cross section (RCS) and overall reflectivity of the object.

Radar cross section (RCS) can be or include a measure of how much energy is reflected back to the radar from a target. RCS may depend on the target's size, shape, material, and orientation, among other measures of the target. Larger objects or objects with highly reflective surfaces may have a higher RCS. The CFAR algorithm may provide the framework to estimate the RCS by comparing the returned signal strength (intensity) to the known transmission power and range. Reporting RCS can help the radar system distinguish between different object types, such as vehicles, pedestrians, or small obstacles, etc.

Detector margin may be or include the difference between the detected signal's intensity and the detection threshold set by the CFAR algorithm. The detector margin provides insight into how confidently a signal was identified as a target versus noise. A larger detector margin indicates that the target is well above the noise level, making it easier to classify and track. The CFAR algorithm may automatically adjust the threshold based on the local noise floor, and reporting the detector margin can provide feedback on detection robustness.

The combined model can include a machine-learning-based model, which can involve deep learning or other suitable types of machine learning. In some examples, the machine-learning-based model can include a CNN architecture that can include three convolutional layers and a softmax activation layer at the end. Other suitable types or numbers of layers are possible to include in the machine-learning-based model. In some examples, a first convolutional layer can include five filters with kernel size 2×2, a second convolutional layer can include three filters with kernel size 2×2, and an output layer can include one filter with kernel size 1×1. Other suitable numbers of filters per layer and kernel sizes are possible for the layers of the machine-learning-based model. The machine-learning-based model can use an activation function such as ReLU or Swish (intermediate layers) or sigmoid (output layer). The sigmoid activation function can output values between zero and one, representing a probability of target presence for a corresponding pixel on the RD map. A threshold, such as a hard threshold or an adaptive threshold, can be applied to the pixels of the RD map to convert the output into a binary decision, in which values closer to one indicate target presence and values closer to zero indicate noise.

The machine-learning-based model can include or otherwise use a loss function. The machine-learning-based model can be compiled using the Binary Focal Loss with a gamma value of 2.0 though other loss functions and/or gamma values may be alternatively used. The loss function may be effective in dealing with imbalanced data in which the number of target pixels is much smaller than the number of noise pixels in the RD map. In some examples, the machine-learning-based model can use or involve the Adam optimizer for training the machine-learning-based model, ensuring fast convergence and adaptability to different learning rates. Other suitable optimizers are possible to use with respect to the machine-learning-based model. Additionally or alternatively, the training batch size of the machine-learning-based model may be set to 64 to ensure efficient use of memory, while also allowing the machine-learning-based model to train on multiple samples simultaneously. Additionally or alternatively, the model may be trained for a maximum of 250 epochs, with early stopping set to a patience of 10 epochs to prevent overfitting and to reduce unnecessary training cycles. Other numbers of training batch sizes and/or epochs may be used for training the machine-learning-based model.

The combined model, such as a combination of at least the machine-learning-based model and the CFAR algorithm, can have numerous benefits compared with other models or techniques for target detection in an environment. For example, the number of parameters of the machine-learning-based model may be kept below approximately 100, which can make the model extremely lightweight and suitable for real-time radar applications. Additionally or alternatively, the model weights may be approximately 3 kB, making the model deployable on memory-constrained environments such as automotive radar DSPs. Additionally or alternatively, the combined model, or any sub-model or sub-service thereof, can be robust to parameter changes. That is, by training the model on a variety of noise levels and target scenarios, the model may become highly robust to changes in parameters, ensuring stable performance across different environments. Additionally or alternatively, false alarms with the combined model may be reduced compared with other techniques. For example, the use of Binary Focal Loss helps to minimize the occurrence of false alarms, which may be important in radar systems where the cost of a false alarm can be significant (e.g., unnecessary braking in autonomous vehicles).

The combined model, or the machine-learning model thereof, can begin with an input layer. The input layer may receive an RD map with one channel in which the RD map may be in a dB scale, which may be continuous. The input layer may be designed to accept RD maps with a single channel, which can represent the radar signal intensity in decibels. This layer is flexible, meaning it can take in RD maps of different resolutions without needing any adjustments. By feeding the RD map directly into the network, the spatial information about the target signals and noise can be preserved for further analysis by the subsequent layers.

The combined model, or the machine-learning-based model thereof, may continue with a first convolutional layer. The first convolutional layer may include five filters each (or a subset thereof) of size 2×2. The first convolutional layer may include an ReLU activation function, though the Swish activation function may be used in place of the ReLU activation function. An output of the first convolutional layer may have the same dimensions as the input to the first convolutional layer, meaning the padding of the layer may be “same”. In some examples, the first convolutional layer can detect basic patterns, such as edges or small target peaks, across the RD map. The use of multiple filters in the first convolutional layer can allow the machine-learning-based model to identify different types of features that can indicate the presence of a target, even if those features vary in shape or orientation. The 2×2 kernel size can allow the machine-learning-based model to focus on localized details to capture the subtle changes in the radar signal that could represent small targets. With ReLU activation, the machine-learning-based model can ignore negative values, making it easier to distinguish target-like patterns from noise.

The combined model, or the machine-learning-based model thereof, may continue with a second convolutional layer. The second convolutional layer may include three filters each (or a subset thereof) of size 2×2. The second convolutional layer may include an ReLU activation function, though the Swish activation function may be used in place of the ReLU activation function. An output of the second convolutional layer may have the same dimensions as the input to the second convolutional layer, meaning the padding of the layer may be “same”. In some examples, the second convolutional layer may refine the detected features from the first convolutional layer, focusing more on complex patterns that distinguish targets from noise. By reducing the number of filters from the first convolutional layer to the second convolutional layer, the model can focus on more nuanced aspects of the radar data such as patterns that distinguish actual targets from clutter or background noise. The filters may be or include fine-tuning tools that combine information from nearby pixels, making it easier for the network to decide whether a detected feature is truly a target or just an anomaly. The ReLU activation can ensure that only significant features are passed forward, making the decision-making process more robust.

The combined model, or the machine-learning-based model thereof, may continue with an output convolutional layer that can include one filter of size 1×1. The activation function of the output convolutional layer may be or include a sigmoid function. In some examples, the output convolutional layer may reduce the feature maps to a single binary decision per pixel, indicating whether a target is present or not in each corresponding cell of the RD map. The final convolutional layer can use a single 1×1 filter to reduce the feature maps into a single decision for each pixel for indicating whether a target is present. The 1×1 filter can act as a classifier that looks at all the refined information gathered from the previous layers and makes a simple yes-or-no decision for each location in the RD map. The sigmoid activation function can ensure that these decisions are normalized into values between 0 and 1, essentially creating a probability map where each pixel's value indicates the likelihood of a target being present.

After the RD map is passed through the machine-learning-based model, there can include two options for generating a binary map: CFAR processing (adaptive thresholding) and hard thresholding. For CFAR processing, the sigmoid output may be first denormalized and then processed using a T-CFAR model. This approach applies an adaptive threshold to create a binary map, identifying target locations. For hard thresholding, the sigmoid output may be first denormalized, and then a fixed threshold (e.g., 15 dB) may be applied. Pixels with values above the hard threshold, the range-based variational threshold, or the adaptive threshold, may be classified as targets (such as with a binary value of 1), while others are classified as non-targets (such as with a binary of 0). This approach is simpler and faster than other techniques, offering a straightforward way to produce a binary map. In both cases, denormalization may ensure that the values reflect the original scale before thresholding, providing a more accurate basis for target identification.

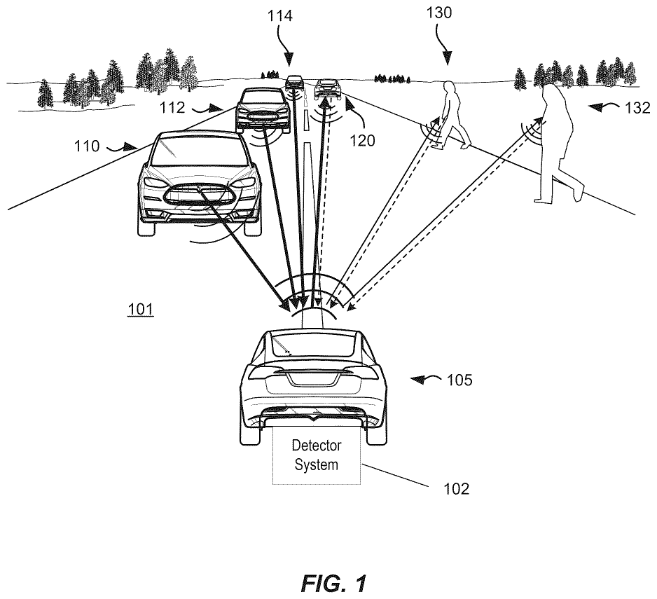

FIG. 1 is a diagram illustrating an environment in which a machine-learning-based model can be used for generating a binary map of targets in the environment according to an embodiment of the present invention. As illustrated in FIG. 1, various targets can be positioned in an environment 101 surrounding a vehicle 105 that can include a detector system 102 that can include or use the machine-learning-based model. The targets can include a first target 110, a second target 112, a third target 114, a fourth target 120, a fifth target 130, and a sixth target 132. In some embodiments, the targets can include various combinations of people, animals, vehicles, trees or other plants, and other targets with which the vehicle 105 may avoid a collision using the detector system 102.

In some embodiments, the vehicle 105 may be an autonomous vehicle such as an autonomous car, and the vehicle 105 may have the detector system 102 integrated into the vehicle 105 to allow data detected by hardware of the vehicle 105, or of the detector system 102 and relating to the vehicle 105, to be processed and used to control the vehicle 105. For example, the detector system 102 may be positioned on the vehicle 105, and the detector system 102 may include one or more detectors such as radar detectors, LiDAR detectors, camera detectors, or other suitable position detectors. The one or more detectors can detect data about the targets in the environment, and the data can be input into a machine-learning-based model, which may be combined with other models or techniques, such as a denormalization operation, a CFAR algorithm, etc. The machine-learning-based model may process the data, which may be input as an RD map that includes a set of pixels, to determine one or more pixels at which a target may, or is likely to, exist.

In a particular example, the vehicle 105 may be autonomously proceeding in the environment 101, and the detector system 102 may continuously generate a radar doppler (RD) map. The RD map may include a set of pixels in which each pixel of the set of pixels represents a different location in the environment 101. The detector system 102 may process the RD map using a combined model that can include a machine-learning-based model, a CFAR algorithm, etc., and the processed RD map can be converted to a binary map that includes the set of pixels with altered values thereof. That is, the processing of the RD map may alter the values of the pixels but may otherwise retain the set of pixels. For example, while the values of the pixels may be altered, the locations represented by the pixels may remain unchanged. The binary map may include the set of pixels having one of two possible values: a first value indicating a target at a corresponding location and a second value indicating no target (noise) at the corresponding location. The vehicle 105, or any control system thereof, may use the binary map to control a trajectory of the vehicle 105. For example, if a preexisting trajectory of the vehicle 105 passes through a particular location that the binary map indicates as including a target, then the vehicle 105, or the control system thereof, can adjust the trajectory to attempt to avoid a collision between the vehicle 105 and the target. Additionally or alternatively, if a preexisting trajectory of the vehicle 105 does not pass through a particular location that the binary map indicates as including a target, then the vehicle 105, or the control system thereof, can control the trajectory by retaining the preexisting trajectory.

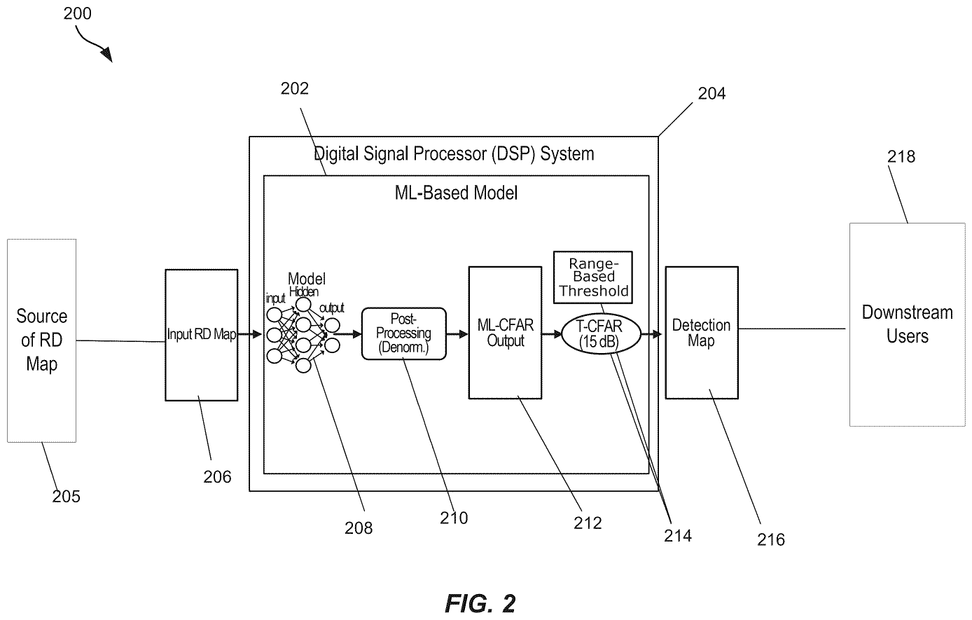

FIG. 2 is a diagram of a machine-learning-based system 200 for generating a binary map of targets in an environment according to an embodiment of the present invention. The machine-learning-based system 200 may be or be included in the detector system 102 as illustrated and described with respect to FIG. 1. In some embodiments, the machine-learning-based system 200 can include a machine-learning-based model 202, that can be included in a digital signal processor (DSP) 204. The machine-learning-based system 200 may be used to generate a binary map of targets based on input data that can include an RD map or other suitable maps of the environment.

As illustrated in FIG. 2, input into the machine-learning-based system 200 can include a source 205 of an RD map 206. That is, one or more detectors, or other devices configured for generating the RD map 206, can be at least communicatively coupled with the machine-learning-based system 200, and the one or more detectors, or other devices, can transmit the input including the RD map 206 to the machine-learning-based system 200 for initiating processing. The machine-learning-based model 202 may be included in the DSP 204 and may include a machine-learning model 208. In some embodiments, the machine-learning model 208 may be or include a deep learning model such as a convolutional neural network, though other suitable types of machine-learning models are possible for the machine-learning model 208. The machine-learning model 208 may receive the RD map 206 and may alter the values of at least a subset of the pixels included in the RD map 206 to perform a stretching operation. The stretching operation may involve increasing an intensity or other value of pixels that are likely to represent locations having a target, and the stretching operation may involve decreasing an intensity or other value of pixels that are not likely to represent locations having a target or that are otherwise likely to represent noise. An output of the machine-learning model 208 may be or include an intermediate map that can include the same or similar set of pixels from the RD map 206 in which the values of the set of pixels may be altered.

The intermediate map may be further processed by a denormalization operation 210 of the machine-learning-based model 202. That is, the denormalization operation 210 may denormalize the values of the set of pixels of the intermediate map to further stretch the target indications from the noise data. In some embodiments, the denormalization operation 210 may involve adjusting minimum and maximum intensity levels of pixels in the intermediate map to stretch a distance, with respect to intensity, between the minimum and maximum intensity levels of the pixels. An output of the denormalization operation 210 may include an adjusted intermediate map 212 that can have similar or identical pixels as the intermediate map and/or the RD map 206 but may have different values of those pixels.

The adjusted intermediate map 212 can be further processed such as by a thresholding operation 214. The thresholding operation 214 may include a hard thresholding operation, an adaptive thresholding operation, a range-based variational thresholding operation, or some combination thereof. For example, a hard threshold, in units of dB, may be applied to each pixel of the set of pixels of the adjusted intermediate map 212. In some examples, the adaptive threshold may involve applying a CFAR algorithm to each pixel of the set of pixels. Applying the CFAR algorithm may involve applying an adaptive threshold, which may not be the same for each pixel, to each pixel. If a pixel has a corresponding value above the hard threshold or the adaptive threshold, then the thresholding operation 214 may set the value of the pixel to a first binary value that indicates a target is present at a location corresponding with the pixel. If the pixel has a corresponding value that is not above the hard threshold or the adaptive threshold, then the thresholding operation 214 may set the value of the pixel to a second binary value that indicates that a target is not present at a location corresponding with the pixel or otherwise that the data associated with the pixel is noise. In some examples, the binary values may be one and zero, though other suitable binary values may be used.

An output of the thresholding operation 214 can include a binary map 216 that can include the same or similar set of pixels as the adjusted intermediate map 212, the intermediate map, and/or the RD map 206. The set of pixels of the binary map 216 may be adjusted to each be one of two binary values to make decision-making processes using the binary map 216 easy or otherwise not computationally intensive. For example, the binary map 216 can be provided to downstream users 218 that can use the binary map 216 to make decisions relating to an environment implicated by the binary map 216. As in the example illustrated in FIG. 1, the vehicle 105, or the control system thereof, can receive the binary map 216, for example from the detector system 102 and/or the DSP 204, and the vehicle 105, or the control system thereof, can control or alter a trajectory of the vehicle 105 to avoid collisions in the environment 101. Other downstream users, such as other than the vehicle 105, are possible for the downstream users 218.

In some embodiments, the RD map can provide information about the range and velocity of surrounding targets. However, if there are two objects, such as vehicles, located at the same range and moving with the same velocity but positioned at different azimuth angles, the RD map may represent them as a single target. To differentiate between such targets, additional processing can be performed via direction of arrival (DoA) estimation, which generates a point cloud. The point cloud provides spatial information, including the azimuth and elevation of the targets, enabling their accurate localization.

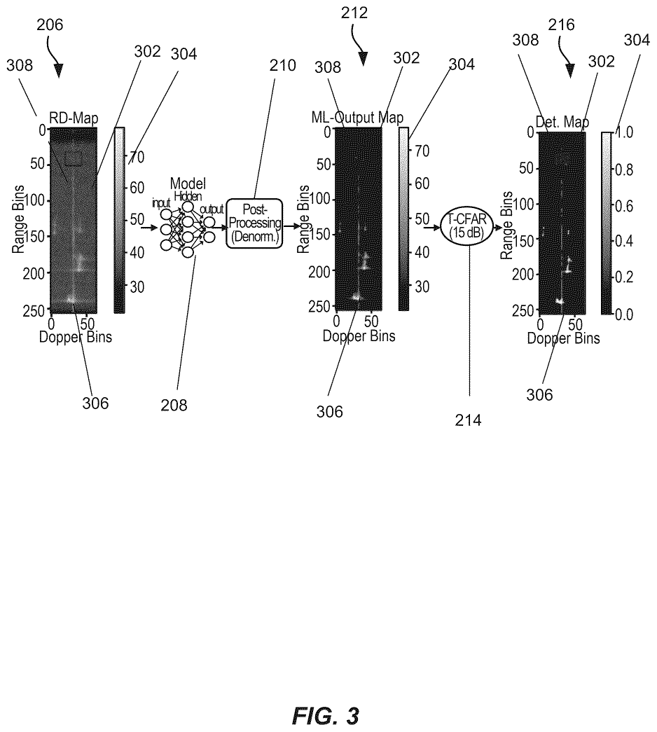

FIG. 3 is a set of radar-based maps that includes a binary map of targets in an environment according to an embodiment of the present invention. As illustrated in FIG. 3, an RD map 206 can be provided as an input. The RD map 206 can include a set of pixels 302, and an example of the set of pixels 302 are illustrated in FIG. 3. Each pixel of the set of pixels 302 can represent a different location in an environment such as the environment 101. Additionally or alternatively, each pixel of the set of pixels 302 can have an associated value that can indicate whether a target is likely to be present at a corresponding location. In some examples, the RD map 206 can be illustrated as a heat map that corresponds with values of the set of pixels 302. That is, a higher value for a particular pixel may result in a first color (e.g., indicating the higher value) being used to populate the particular pixels. Additionally or alternatively, noise data may have a second color different from the first color in which the second color indicates that the data associated with the particular pixel is likely to be noise. The RD map 206 can additionally include a legend 304 that can indicate whether colors on the RD map 206 correspond more with target data, such as at a first pixel 306, or noise data such as at a second pixel 308.

The RD map 206 can be provided to the machine-learning-based model 208, which can use deep learning to perform a stretching operation on the values of the set of pixels 302. For example, the machine-learning-based model 208 can use convolutional layers and/or other suitable machine-learning layers and/or techniques to enhance (e.g., increase) values that indicate a target and to suppress (e.g., decrease) values that indicate noise. Additionally or alternatively, the denormalization operation 210 can be performed on an output of the machine-learning-based model 208 to generate an intermediate map and/or the adjusted intermediate map 212. As illustrated in FIG. 3, the output of the denormalization operation 210 is the adjusted intermediate map 212, which includes the set of pixels 302 and the legend 304. The set of pixels 302 in the adjusted intermediate map 212 may be similar or identical to the set of pixels 302 in the RD map 206. That is, the set of pixels 302 in the adjusted intermediate map 212 may represent the same or similar locations in an environment as the set of pixels 302 in the RD map 206. The values of the set of pixels 302 in the adjusted intermediate map 212 may be adjusted, such as increased or decreases, from the values of the set of pixels 302 in the RD map 206.

The adjusted intermediate map 212 can be further processed, for example via the thresholding operation 214. The thresholding operation 214 can include a hard threshold, a range-based variational thresholding operation, or an adaptive threshold such as via a CFAR algorithm. The thresholding operation 214 can cause the adjusted intermediate map 212 to be converted to the binary map 216 that can include the set of pixels 302 and the legend 304. The set of pixels 302 in the binary map 216 may be similar or identical to the set of pixels 302 in the RD map 206 and/or the adjusted intermediate map 212. That is, the set of pixels 302 in the binary map 216 may represent the same or similar locations in an environment as the set of pixels 302 in the RD map 206 and/or the adjusted intermediate map 212. The values of the set of pixels 302 in the binary map 216 may be adjusted, such as increased or decreased, from the values of the set of pixels 302 in the RD map 206 and/or the adjusted intermediate map 212. For example, the thresholding operation 214 may cause the value of each pixel of the set of pixels 302 of the adjusted intermediate map 212 to converge to one of two binary values. As illustrated in FIG. 3, the value of the first pixel 306 is set to a first binary value (one, indicating a target), and the value of the second pixel 308 is set to a second binary value (zero, indicating noise).

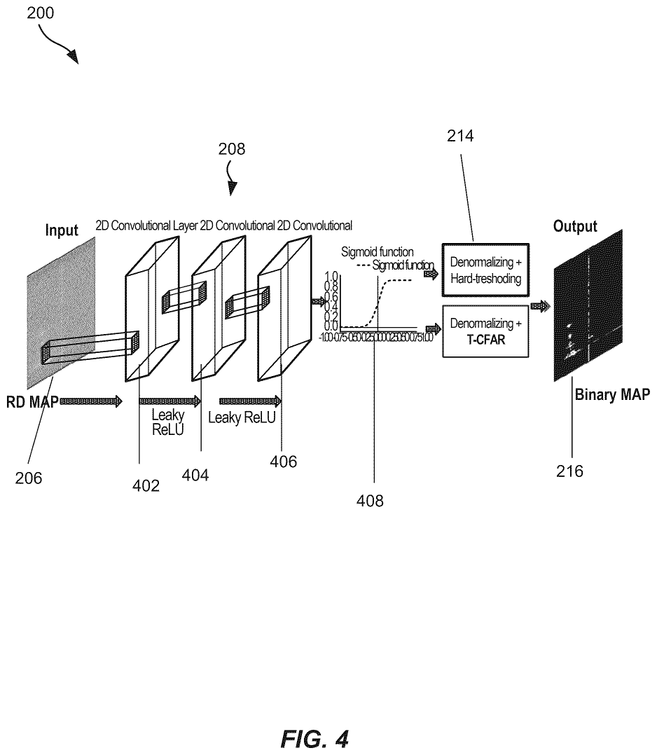

FIG. 4 is a diagram of a machine-learning-based model of a machine-learning-based system 200 for generating a binary map of targets in an environment according to an embodiment of the present invention. As illustrated in FIG. 4, the machine-learning-based system 200 can include the machine-learning-based model 208 along with various other operations and/or services to provide functionality for the machine-learning-based system 200. In some embodiments, the machine-learning-based system 200 may be configured to receive an input RD map, such as the RD map 206, and to provide output including a binary map such as the binary map 216. To generate the binary map output, the machine-learning-based system 200 may perform various processing operations such as stretching, denormalization, convolution, etc.

In some examples, the machine-learning-based system 200 can receive the RD map 206, which can include a set of pixels such as the set of pixels 302. The machine-learning-based system 200 may ingest the RD map 206 into the machine-learning-based model 208 to perform one or more deep learning operations on the set of pixels of the RD map 206. For example, the machine-learning-based model 208 may include or be a convolutional neural network with multiple layers for processing the set of pixels of the RD map 206. As illustrated in FIG. 4, the machine-learning-based model 208 can include three layers: a first convolutional layer 402, a second convolutional layer 404, and an output layer 406, though other suitable numbers (e.g., less than three or more than three) of layers are possible for the machine-learning-based model 208.

The first convolutional layer 402 may include five filters each (or a subset thereof) of size 2×2, though the number of filters and the size thereof may be different. The first convolutional layer 402 may include an ReLU activation function, though the Swish activation function (or other suitable activation functions) may be used in place of the ReLU activation function. An output of the first convolutional layer 402 may have the same dimensions as the input to the first convolutional layer 402, meaning the padding of the layer may be “same”. In some examples, the first convolutional layer 402 can detect basic patterns, such as edges or small target peaks, across the RD map 206 or the set of pixels thereof. The use of multiple filters in the first convolutional layer 402 can allow the machine-learning-based model 208 to identify different types of features that can indicate the presence of a target, even if those features vary in shape or orientation. The 2×2 kernel size can allow the machine-learning-based model 208 to focus on localized details to capture the subtle changes in the radar signal that could represent small targets. With ReLU activation, the machine-learning-based model 208 can ignore negative values, making it easier to distinguish target-like patterns from noise.

The second convolutional layer 404 may include three filters each (or a subset thereof) of size 2×2, though the number of filters and the size thereof may be different. The second convolutional layer 404 may include an ReLU activation function, though the Swish activation function (or other suitable activation functions) may be used in place of the ReLU activation function. An output of the second convolutional layer 404 may have the same dimensions as the input to the second convolutional layer 404, meaning the padding of the layer may be “same”. In some examples, the second convolutional layer 404 may refine the detected features from the first convolutional layer 402, focusing more on complex patterns that distinguish targets from noise. By reducing the number of filters from the first convolutional layer 402 to the second convolutional layer 404, the machine-learning-based model 208 can focus on more nuanced aspects of the radar data such as patterns that distinguish actual targets from clutter or background noise. The filters may be or include fine-tuning tools that combine information from nearby pixels, making it easier for the network to decide whether a detected feature is truly a target or just an anomaly. The ReLU activation can ensure that only significant features are passed forward, making the decision-making process more robust.

The output layer 406 may be or include an output convolutional layer that can include one filter of size 1×1, though the number of filters and the size thereof may be different. The activation function of the output layer 406 may be or include a sigmoid function. In some examples, the output layer 406 may reduce the feature maps to a single binary decision per pixel, indicating whether a target is present or not in each corresponding cell of the RD map 206. The output layer 406 can use a single 1×1 filter to reduce the feature maps into a single decision for each pixel for indicating whether a target is present. The 1×1 filter can act as a classifier that looks at all the refined information gathered from the previous layers and makes a simple yes-or-no decision for each location in the RD map 206. The sigmoid activation function can ensure that these decisions are normalized into values between 0 and 1, essentially creating a probability map where each pixel's value indicates the likelihood of a target being present.

After the RD map 206 is passed through the machine-learning-based model 208, there can include two options for performing the thresholding operation 214 for generating a binary map: CFAR processing (adaptive thresholding) and hard thresholding. For CFAR processing, the sigmoid output 408 may be first denormalized and then processed using a T-CFAR model. This approach applies an adaptive threshold to create the binary map 216, identifying target locations. For hard thresholding, the sigmoid output 408 may be first denormalized, and then a fixed threshold (e.g., 15 dB) may be applied. Pixels with values above the hard threshold may be classified as targets (such as with a binary value of 1), while others are classified as non-targets (such as with a binary of 0). The binary map 216 may be output for decision-making processes or for other suitable purposes.

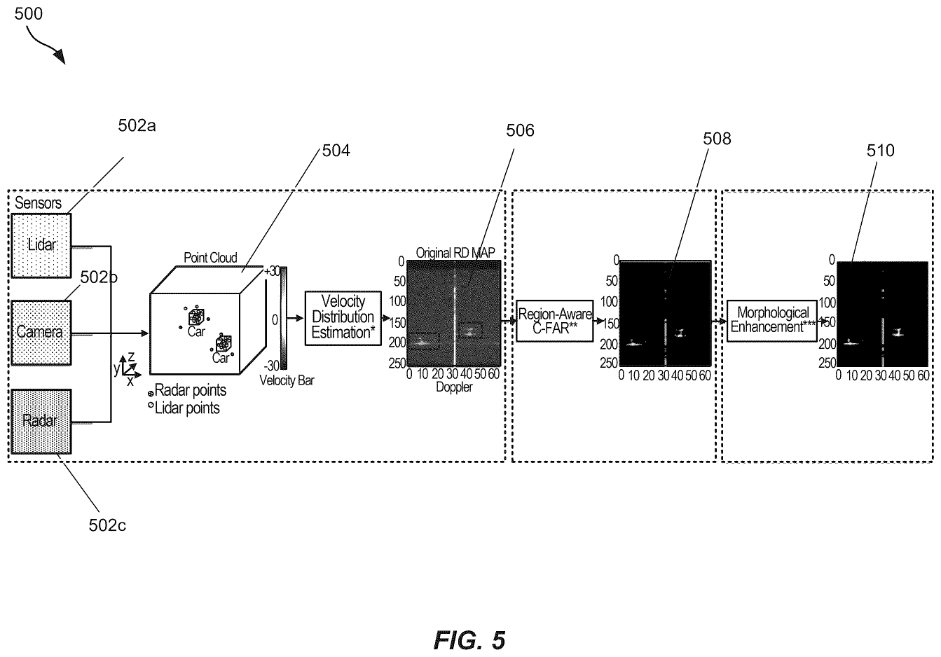

FIG. 5 is a diagram of a data flow for generating a ground truth for a training process for a machine-learning model of a machine-learning system for generating a binary map of targets in an environment according to an embodiment of the present invention. As illustrated in FIG. 5, the data flow 500 may begin with a set of sensors that can include a first sensor 502a, a second sensor 502b, and a third sensor 502c. In some examples, the first sensor 502a may be or include a LiDAR sensor, the second sensor 502b may be or include a camera sensor, and the third sensor 502c may be or include a radar sensor, though other permutations or types of sensors are possible for the set of sensors. The data flow 500 may begin with synchronizing data from the set of sensors in a multi-step approach to integrate various sensor modalities to generate accurate annotations in an RD map. The radar data can be processed using a radar signal processing pipeline that can include performing one or more Fast Fourier Transforms (e.g., FFT1 and/or FFT2) to transform the raw radar signals into an RD map such as RD map 206. After generating the RD map, a CFAR detection algorithm can be applied to identify potential target points within the RD map. The CFAR detection algorithm can output a preliminary 3D point cloud 504 in Cartesian coordinates, with velocity information included for each detected point. For example, the point cloud 504 can include or can be used to generate a velocity distribution estimate 506 of targets in the RD map. The radar data can be collected in synchronization with both LiDAR and camera inputs, such as via the first sensor 502a and the second sensor 502b. This ensures that all sensors are capturing the same scene at the same time, allowing for accurate sensor fusion and cross-referencing of the data.

The 3D point cloud generated from radar data in Cartesian coordinates can provide an initial set of points representing the detected target. However, due to radar's relatively lower spatial resolution, the 3D point cloud may be insufficient for accurately defining the object's exact location and boundaries. Data from LiDAR and camera sensors, such as the first sensor 502a and the second sensor 502b, can be integrated with the radar data. The LiDAR and camera data can offer higher spatial precision and complementary information. LiDAR data can provide detailed 3D measurements of the object's surface, offering highly accurate range and angular positioning that allows the outer edges and overall dimensions of the object to be defined in 3D space. This spatial accuracy can be used to create a well-defined bounding box that fully encapsulates the target. In parallel, camera data can add a visual layer of information, capturing the object's shape, size, and orientation in the scene. By correlating the object's appearance in the camera's 2D image with the corresponding LiDAR and radar detections, the bounding box dimensions can be adjusted and/or validated. The process of fusing data from the set of sensors can leverage the strengths of each modality: the LiDAR data primarily drives the precision of the bounding box in Cartesian coordinates, while camera data ensures proper orientation and visual verification, as an example. As a result, the bounding box generated around the object may be more precise and aligned with both the spatial reality provided by LiDAR and the visual cues from the camera. To further ensure completeness, a margin can be added based on the object's radial distance to account for any boundary detections, ensuring that the bounding box fully captures all relevant points. This combined approach can create a robust, accurate bounding box that can be mapped back to the RD map for comprehensive analysis and model training.

The margin M may be dependent on the radial distance of the bounding box from the radar sensor and can be calculated as follows:

$$M = 0.75 \times ( 1 + \frac{range}{2} ) \qquad ( Equation 1 )$$

Equation 1 can adjust the margin based on the range of the target, ensuring that objects farther away receive a proportionally larger margin to account for potential detection variability at greater distances. The margin M can be added to the width wᵢ, depth dᵢ, and height dimensions of the bounding box to define the overall size of the bounding box:

$$Width = {w}_{i} + M ( r ) \qquad ( Equation 2 )$$

$$Depth = {d}_{i} + M ( r ) \qquad ( Equation 3 )$$

Equations 2-3 may ensure that any detections near the boundary of the target are captured within the bounding box, improving the accuracy of the object representation in both the Cartesian coordinates and when mapping back to the RD map. In some examples, a Density-Based Spatial Clustering algorithm (DBSCAN) can be applied to the radar point cloud to associate the detected radar points with one another, clustering them into groups that represent individual objects. The DBSCAN can help identify the points that belong to the same target.

Inside the defined bounding box, the velocity of each radar-detected point, or any subset thereof, may be examined. To determine the overall object velocity, the mean of velocity values within the bounding box can be calculated using Equation 4.

$${V}_{mean} = \frac{1}{N} {\sum }_{i = 1}^{N} ( {v}_{{p}_{i}} - {c}_{i} ) \qquad ( Equation 4 )$$

in which νₚ_{ᵢ} represents the velocity of the i-th point and cᵢ is the offset compensation. To assess the velocity dispersion, the standard deviation of the velocity values can be computed using Equation 5.

$$dV = \sqrt{\frac{1}{N} {\sum }_{i = 1}^{N} {( {V}_{mean} - {v}_{{p}_{i}} )}^{2}} \qquad ( Equation 5 )$$

In some examples, Equation 5, or an output thereof, can provide insight into how spread out or concentrated the velocity points are, indicating a coherence in the movement of the target.

For range estimation, the first sensor 502a and the second sensor 502b can be used. The first sensor 502a and the second sensor 502b can provide accurate range data, which can be used to calculate the range dispersion and provide an exact range estimate for the target. The range information can be combined with the radar data from the third sensor 502c to ensure that the position of the object in both range and velocity domains is accurately represented.

Once the bounding box, velocity, and range estimations are finalized, this information can be mapped back to the RD map. A small margin or offset can be applied to doppler bins during the mapping to ensure that the entire target is captured within the box on the RD map. As a result, a precise ground truth bounding box in the RD map can be achieved, which can enable highly accurate radar-based object detection and evaluation.

By following the above-described process, the velocity, range, and position of the target can be accurately annotated within the RD map via a bounding box. The bounding box can represent the ground truth for the target in both the range and Doppler domains, allowing for precise comparison and model evaluation. The above-described approach leverages the strengths of different sensor modalities (e.g., radar for velocity measurement and the precision of LiDAR and camera systems for range estimation) for ensuring an accurate and comprehensive ground truth annotation for radar-based detection models.

In some examples, the velocity distribution estimate 506 based on the point cloud 504 can be further processed by a CFAR algorithm, such as a region-aware CFAR algorithm, to generate a processed velocity distribution estimate 508. The CFAR algorithm can cause targets in the RD map to become clearer or to otherwise be able to better highlight potential targets indicated by the RD map. Additionally or alternatively, the processed velocity distribution estimate 508 can be further processed, such as by morphological enhancement, to generate a morphologically enhanced velocity distribution estimate 510 that can be used to annotate the RD map to generate the ground truth for the training process. For example, and after implementing region-aware CFAR on the RD map, a morphological operation can be applied to further refine the detected targets. This step addresses the windowing limitations inherent in traditional CFAR methods, which can lead to the loss of target information, particularly for targets extended in both range and doppler (velocity) domains. The morphological operation can help recover additional points that may have been missed during CFAR processing, enhancing the representation of extended targets and improving overall target detection performance.

In some examples, the region-aware CFAR approach can be used to improve target point detection within the RD map based on pre-identified bounding boxes that include or indicate the target objects. This approach may significantly enhance the density of detected target points, addressing the limitations of traditional CFAR algorithms by varying the detection threshold based on location within the RD map. After generating the RD map, the bounding box can be defined using prior data such as sensor fusion or ground truth. The bounding boxes can ensure that the regions that include potential targets can be precisely identified, which can allow exclusion of non-target areas from detailed analysis. Points outside of the bounding box are unlikely to include targets.

In an approach involving the region-aware CFAR algorithm, two distinct threshold values may be applied. Inside the bounding box in which target detections may be expected, a lower threshold, such as less than approximately 12 dB, can be used. The lower threshold enhances the sensitivity of detection in these areas, enabling the detection of weaker signals that might otherwise be missed with a higher threshold. Outside of the bounding box, in regions in which targets may not be expected, a higher threshold, such as approximately 18 dB, can be applied. The higher threshold can ensure that only very strong reflections (if any) are detected in these areas, reducing the likelihood of false alarms. The traditional CFAR algorithm may apply a single threshold, such as approximately 15 dB, across the entire RD map, which can be too high for weak targets inside the bounding box and too low for non-target areas outside, leading to suboptimal results.

Inside the bounding box, using the smaller threshold can enable the detection of more target points, particularly weaker points (such as vulnerable targets or far distance target) that traditional CFAR algorithms alone might miss. The region-aware CFAR can generate a much richer detection map inside the target's bounding box, with a high density of points representing the target. The detection map inside the target's bounding box can include a percentile map that can show that the lower threshold results in a broader spread of detections across the target area, ensuring that significant points can be identified. By applying the higher threshold outside the bounding box, unnecessary noise and false detections can be prevented from cluttering the results.

Once the ground truth, bounding boxes, etc. are established, the RD map, which may have been annotated, can be provided to the machine-learning-based system 200, or the model 208 thereof, for training. The binary map generated at the end of the above-described operations can serve as the ground truth labels for training the machine-learning-based model. During the training process, the machine-learning-based model can learn to generalize from the dataset of the ground truth, becoming resilient to the challenges typically associated with radar-based detection systems such as false alarms, noise interference, and low-SNR targets. As a result, the machine-learning-based model can be trained to detect a higher number of points with improved accuracy, even in difficult conditions in which traditional CFAR or detection algorithms alone would struggle.

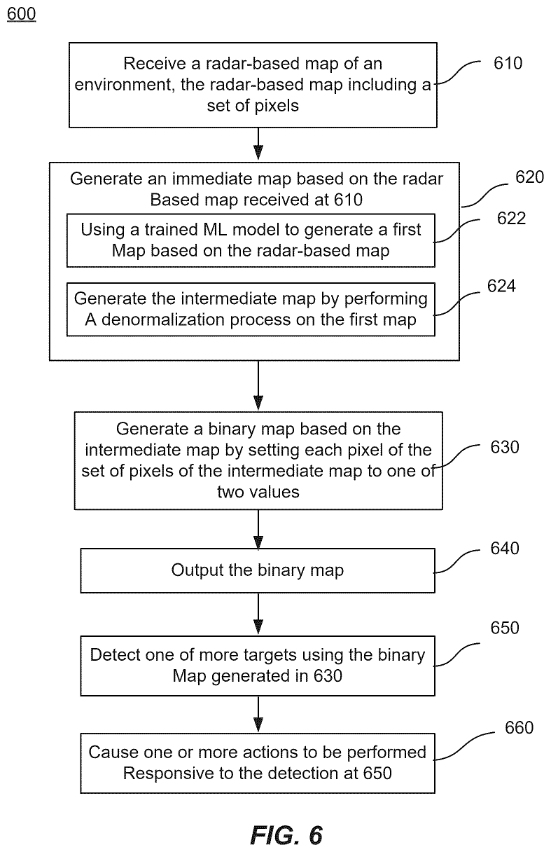

FIG. 6 is a flowchart of a process 600 for generating a binary map of targets in the environment according to an embodiment of the present invention. At 610, a radar-based map of an environment is received. The radar-based map may be or include an RD map such as RD map 206, though other radar-based maps are possible within the scope of the process 600. Additionally or alternatively, the environment may be similar or identical to the environment 101, though other suitable environments are possible. In some examples, the radar-based map can include a set of pixels, and each pixel of the set of pixels can represent a different physical location within the environment. The radar-based map may be generated by a detector system such as detector system 102. In some examples, the radar-based map can be generated by one or more radar detectors that can detect at least a position of potential targets in the environment. In other examples, the radar detectors may be combined with camera detectors, LiDAR detectors, etc. to enhance the radar-based map or to enhance a training process for training the detector system or any machine-learning-based model thereof.

At 620, an intermediate map is generated based on the radar-based map using a trained machine-learning model. In some examples, 620 may include operations 622 and 624. In some examples, the trained machine-learning model may be or be included in the machine-learning-based system 200, and the trained machine-learning model may be the machine-learning-based model 208. The trained machine-learning model may be trained using one or more operations such as those illustrated and described with respect to FIG. 5. In some examples, the radar-based map may be altered by the trained machine-learning model such as at 622. For example, the values of the pixels included in the radar-based map may be altered to generate a first map based on the radar-based map. In some examples, the first map may have the same set of pixels as the radar-based map, or a set of pixels corresponding thereto, but the set of pixels of the first map may have different values than the values associated with the set of pixels of the radar-based map. The values may be adjusted by being increased or decreased. For example, the trained machine-learning model may increase a particular value of a particular pixel if features or attributes of the particular pixel detected by the trained machine-learning model indicate that a target is likely to be present at a location in the environment corresponding with the particular pixel. Additionally or alternatively, the trained machine-learning model may decrease a particular value of a particular pixel if features or attributes of the particular pixel detected by the trained machine-learning model indicate that a target is not likely to be present at a location in the environment corresponding with the particular pixel. In some embodiments, generating the intermediate map using the trained machine-learning model can include using a denormalization operation, such as at 624, in combination with the trained machine-learning model to generate the intermediate map.

At 630, a binary map is generated based on the intermediate map. For example, each pixel of the set of pixels included in the intermediate map can be set to one of two binary values. The two binary values may include zero (indicating noise) and one (indicating target), but other suitable binary values are possible for the two binary values. In some examples, the binary map may be generated by applying a thresholding operation to the intermediate map or other suitable output from the trained machine-learning model. The thresholding operation can involve applying a hard threshold, or a range-based variational threshold, to each pixel of the set of pixels, applying an adaptive threshold to each pixel of the set of pixels, or applying another suitable threshold to each pixel of the set of pixels. In examples in which the adaptive threshold is applied to each pixel of the set of pixels, a CFAR algorithm can be used to apply the adaptive threshold. The thresholding operation can be a decision-making process for each pixel of the set of pixels. For example, the thresholding operation can make a determination for each pixel of the set of pixels whether the pixel indicates noise or a target. Based on the determination, the value of the pixel can be adjusted to one of the two binary values.

At 640, the binary map is output. In some examples, the binary map can be output to control a real-world operation. In other examples, outputting the binary map can include using the binary map for positively identifying one or more targets in the environment. Outputting the binary map can additionally or alternatively include providing the binary map to an autonomous vehicle following a trajectory. The binary map, or a point cloud generated based on the RD map, can be used, for example by the autonomous vehicle or any control system thereof, to alter the trajectory of the autonomous vehicle. In some examples, the trajectory of the autonomous vehicle can be altered to avoid a collision with a particular target in the environment indicated by the binary map. The point cloud may be generated based on the RD map to aid with altering the trajectory of the autonomous vehicle.

At 650, one or more targets are detected using the binary map. The one or more targets may be located in the environment surrounding the vehicle, and the binary map, such as via the one of two binary values, may indicate the locations of the one or more targets. A computing system, such as a computing system of the vehicle, may determine that the one or more targets are detected in the environment by using the binary map as input.

At 660, and responsive to detecting the one or more targets at 650, one or more actions are performed. For example, the one or more actions may include altering a trajectory of motion of the vehicle to avoid a collision with the one or more targets in the environment. In other examples, the one or more actions may include retaining, or otherwise unchanging, the trajectory of motion of the vehicle.

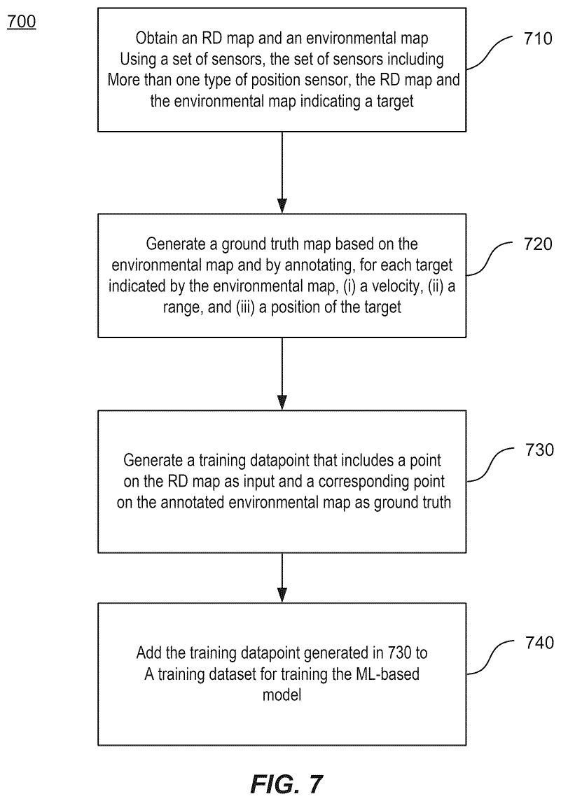

FIG. 7 is a flowchart of a process 700 for generating a ground truth map for training a machine-learning model a machine-learning system for generating a binary map of targets in an environment according to an embodiment of the present invention. In some embodiments, the processing described in the process 700 is for generating one training datapoint and adding the training datapoint to a training dataset for training a machine-learning model. At 710, an environmental map and an RD map are obtained. The RD map may be obtained using a radar sensor on a vehicle, and the environmental map may be detected using a set of sensors that can include more than one type of position sensor. In some examples, the set of sensors can include a radar sensor, a LiDAR sensor, a camera sensor, other suitable position sensor, or any combination thereof that can be positioned on the vehicle. The set of sensors may include sensors of different, or at least more than one, modalities. The RD map, the environmental map, or a combination thereof may indicate a target in the environment.

At 720, a ground truth map is generated based on the environmental map. In some examples, data from the set of sensors is fused to allow annotation of the data included in the environmental map. Annotating the data included in the environmental map can involve annotating velocity data, range data, position data, etc. to label the data included in the environmental map.

At 730, a training datapoint is generated based on the RD map and the annotated environmental map. The training datapoint can include a point on the RD map as an input and a corresponding point on the annotated environmental map as the ground truth. At 740, the training datapoint generated in 730 is added to a training dataset that is based on the ground truth map (annotated environmental map). The training dataset can be input into the machine-learning model to train the machine-learning model. The machine-learning model can map inputs to outputs to convert the machine-learning model to the trained machine-learning model.

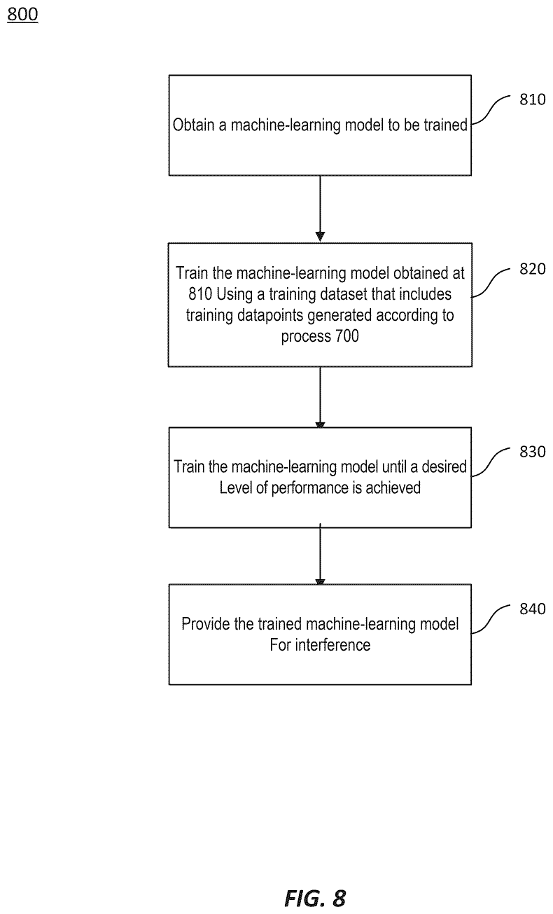

FIG. 8 is a flowchart of a process 800 for training a machine-learning model of a machine-learning system for generating a binary map of targets in an environment according to an embodiment of the present invention. At 810, a machine-learning model is obtained. The machine-learning model may be similar or identical to the machine-learning-based model 202 or may be or include any other suitable machine-learning model that can be trained for generating a binary map for detecting targets in an environment. At 820, the machine-learning model obtained at 810 is trained. Training the machine-learning model can involve inputting training datapoints from a training dataset into the machine-learning model. The training datapoints can be generated based on the processing described with respect to the process 700. At 830, the machine-learning model is trained until a desired level of performance is achieved. At 840, the machine-learning model is provided to facilitate inferencing such as with respect to subsequently received RD maps.

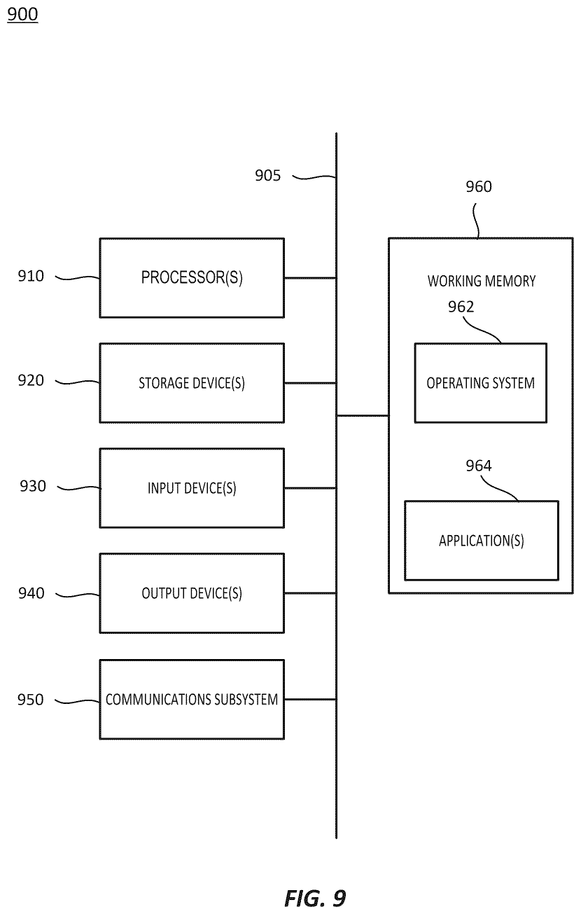

FIG. 9 is a simplified block diagram illustrating components of a radar signal processing system according to an embodiment of the present invention. The radar signal processing system 900 as illustrated in FIG. 9 may be incorporated into a vehicle or other suitable platform utilizing radar data as described herein. FIG. 9 provides a schematic illustration of one embodiment of radar signal processing system 900 that can perform some or all of the steps of the methods or operations provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

Radar signal processing system 900 is shown comprising hardware elements that can be electrically coupled via a bus 905, or may otherwise be in communication, as appropriate. The hardware elements may include one or more processors 910, including without limitation one or more general-purpose processors and/or one or more special-purpose processors such as digital signal processing chips, graphics acceleration processors, and/or the like; one or more input devices 930, which can include without limitation a radar, a mouse, a keyboard, a camera, and/or the like; and one or more output devices 940, which can include without limitation a display device, a printer, and/or the like. Utilizing one or more processors 910, the received radar signals can be processed to detect targets in the presence of interference as discussed herein can be implemented.

Radar signal processing system 900 may further include and/or be in communication with storage device(s) 920 (e.g., one or more non-transitory storage devices), which can comprise without limitation local and/or network accessible storage, and/or can include without limitation a disk drive, a drive array, an optical storage device, a solid-state storage device such as a random access memory (RAM) and/or a read-only memory (ROM) which can be programmable, flash-updateable, and/or the like. Such storage devices may be configured to implement any appropriate data stores including without limitation various file systems, database structures, and/or the like.

Radar signal processing system 900 might also include a communications subsystem 950, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. Communications subsystem 950 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate radar and/or image and/or other information via communications subsystem 950. In other embodiments, a portable electronic device, e.g., the first electronic device, may be incorporated into radar signal processing system 900, e.g., an electronic device as an input device 930. In some embodiments, radar signal processing system 900 will further comprise a working memory 960, which can include a RAM or ROM device, as described above.

Radar signal processing system 900 also can include software elements, shown as being currently located within working memory 960, including an operating system 962, device drivers, executable libraries, and/or other code, such as one or more application programs 964, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as storage device(s) 920 described above. In some cases, the storage medium might be incorporated within a computer system, such as radar signal processing system 900. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by radar signal processing system 900 and/or might take the form of source and/or installable code, which, upon compilation and/or installation on radar signal processing system 900, e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as radar signal processing system 900 to perform methods in accordance with various embodiments of the technology. According to a set of embodiments, some or all procedures of such methods are performed by radar signal processing system 900 in response to one or more processors 910 executing one or more sequences of one or more instructions, which might be incorporated into operating system 962 and/or other code, such as an application program 964, contained in working memory 960. Such instructions may be read into working memory 960 from another computer-readable medium, such as one or more of storage device(s) 920. Merely by way of example, execution of the sequences of instructions contained in working memory 960 might cause one or more processors 910 to perform one or more procedures of the methods described herein. Additionally, or alternatively, portions of the methods described herein may be executed through specialized hardware.

The terms machine-readable medium and computer-readable medium, as used herein, refer to any medium that participates in providing data that causes a machine to operate in a specific fashion. In an embodiment implemented using radar signal processing system 900, various computer-readable media might be involved in providing instructions/code to one or more processors 910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as storage device(s) 920. Volatile media include, without limitation, dynamic memory, such as working memory 960.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to one or more processors 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by radar signal processing system 900.

Communications subsystem 950 and/or components thereof generally will receive signals, and bus 905 then might carry the signals and/or the data, instructions, etc. carried by the signals to working memory 960, from which one or more processors 910 retrieves and executes the instructions. The instructions received by working memory 960 may optionally be stored on storage device(s) 920, e.g., a non-transitory storage device, either before or after execution by one or more processors 910.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a method comprising: receiving a radar-based map of an environment surrounding a vehicle, the radar-based map comprising a plurality of pixels, each pixel of the plurality of pixels having an associated value from a range of values; generating an intermediate map from the radar-based map, the intermediate map comprising a plurality of pixels corresponding to the plurality of pixels in the radar-based map, wherein generating the intermediate map comprises generating a plurality of values for the plurality of pixels in the intermediate map based upon values of the corresponding pixels in the radar-based map, and wherein generating the plurality of pixels values for the plurality of pixels in the intermediate map comprises: for each pixel of a set of pixels of the plurality of pixels in the intermediate map, generating a value for the pixel that is greater than or lower than a value associated with the corresponding pixel in the radar-based map; generating a binary map based on the intermediate map, the binary map comprising a plurality of pixels corresponding to the plurality of pixels in the intermediate map, wherein generating the binary map comprises, for each pixel in the plurality of pixels of the binary map, computing a value for the pixel to a first value or a second value based upon a value of the corresponding pixel in the intermediate map; and outputting the binary map, the binary map comprising information usable for identifying one or more targets in the environment.

Example 2 is the method of example 1, wherein generating the intermediate map comprises: using a machine-learning (ML) model to generate a first map from the radar-based map, the first map comprising a plurality of pixels corresponding to the plurality of pixels in the radar-based map, wherein using the ML model comprises: generating a plurality of values for the plurality of pixels in the first map based upon values of the corresponding pixels in the radar-based map, wherein generating the plurality of pixels values for the plurality of pixels in the first map comprises: for each pixel of a set of pixels of the plurality of pixels in the first map, generating a value for the pixel that is greater than or lower than a value associated with the corresponding pixel in the radar-based map.

Example 3 is the method of example 2, wherein generating the intermediate map further comprises generating the intermediate map from the first map by performing a de-normalization operation on the first map.

Example 4 is the method of example 1, further comprising identifying one or more targets in the environment using the binary map.

Example 5 is the method of example 1, wherein generating the binary map based upon the intermediate map comprises applying a constant false alarm rate (CFAR) algorithm to the intermediate map to generate the binary map.

Example 6 is the method of example 1, wherein the first value is zero and the second value is one.

Example 7 is the method of example 1, wherein generating the intermediate map comprises using a trained machine-learning model that is a trained convolutional neural network (CNN) comprising (i) an input layer, (ii) a first convolution layer, (iii) a second convolution layer, and (iv) an output convolution layer, and wherein a number of model parameters for the trained CNN is less than 100.

Example 8 is the method of example 7, wherein the output convolution layer comprises a sigmoid activation function that generates a sigmoid output, and wherein the method further comprises applying an adaptive threshold value to the intermediate map to determine the first value and/or the second value for the corresponding pixel.

Example 9 is the method of example 1, wherein generating the binary map comprises, for each pixel of the set of pixels of the plurality of pixels in the intermediate map: generating and associating the first value with the pixel if a value associated with the corresponding pixel in the intermediate map is above a threshold; and generating and associating the second value with the pixel if a value associated with the corresponding pixel in the intermediate map is less than or equal to the threshold, wherein the threshold is a hard threshold or an adaptive threshold.

Example 10 is the method of example 1, further comprising training a machine-learning model to generate the trained machine-learning model, wherein training the machine-learning model comprises: detecting an environmental map using a set of sensors, wherein the set of sensors comprises more than one type of position sensor; generating a ground truth map based on the environmental map and by annotating, for each target indicated by the environmental map, (i) a velocity, (ii) a range, and (iii) a position of the target; and inputting the environmental map and the ground truth map into the machine-learning model to train the machine-learning model.

Example 11 is the method of example 1, wherein the radar-based map is used to generate a point cloud that represents an environment surrounding a vehicle in motion, the method further comprising: detecting a first target in the environment using the binary map and the point cloud; and responsive to detecting the first target, altering, based on spatial information included in the point cloud, a trajectory of motion of the vehicle to avoid a collision with the first target.

Example 12 is a system comprising: one or more radar sensors configured to output a radar-based map of an environment, the radar-based map comprising a plurality of pixels, each pixel in the plurality of pixels, each pixel of the plurality of pixels having an associated value from a range of values; one or more processors configured to perform processing comprising: receiving a radar-based map of an environment surrounding a vehicle, the radar-based map comprising a plurality of pixels, each pixel of the plurality of pixels having an associated value from a range of values; generating an intermediate map from the radar-based map, the intermediate map comprising a plurality of pixels corresponding to the plurality of pixels in the radar-based map, wherein the operation of generating the intermediate map comprises generating a plurality of values for the plurality of pixels in the intermediate map based upon values of the corresponding pixels in the radar-based map, and wherein the operation of generating the plurality of pixels values for the plurality of pixels in the intermediate map comprises: for each pixel of a set of pixels of the plurality of pixels in the intermediate map, generating a value for the pixel that is greater than or lower than a value associated with the corresponding pixel in the radar-based map; generating a binary map based on the intermediate map, the binary map comprising a plurality of pixels corresponding to the plurality of pixels in the intermediate map, wherein the operation of generating the binary map comprises, for each pixel in the plurality of pixels of the binary map, computing a value for the pixel to a first value or a second value based upon a value of the corresponding pixel in the intermediate map; and outputting the binary map, the binary map comprising information usable for identifying one or more targets in the environment.

Example 13 is the system of example 12, wherein the operation of generating the intermediate map comprises: using a machine-learning (ML) model to generate a first map from the radar-based map, the first map comprising a plurality of pixels corresponding to the plurality of pixels in the radar-based map, wherein the operation of using the ML model comprises: generating a plurality of values for the plurality of pixels in the first map based upon values of the corresponding pixels in the radar-based map, wherein the operation of generating the plurality of pixels values for the plurality of pixels in the first map comprises: for each pixel of a set of pixels of the plurality of pixels in the first map, generating a value for the pixel that is greater than or lower than a value associated with the corresponding pixel in the radar-based map.

Example 14 is the system of example 13, wherein the operation of generating the intermediate map further comprises generating the intermediate map from the first map by performing a de-normalization operation on the first map.

Example 15 is the system of example 12, wherein the operations further comprise identifying one or more targets in the environment using the binary map.

Example 16 is a non-transitory computer-readable medium comprising instructions executable by one or more processors to cause the one or more processors to perform operations comprising: receiving a radar-based map of an environment surrounding a vehicle, the radar-based map comprising a plurality of pixels, each pixel of the plurality of pixels having an associated value from a range of values; generating an intermediate map from the radar-based map, the intermediate map comprising a plurality of pixels corresponding to the plurality of pixels in the radar-based map, wherein the operation of generating the intermediate map comprises generating a plurality of values for the plurality of pixels in the intermediate map based upon values of the corresponding pixels in the radar-based map, and wherein the operation of generating the plurality of pixels values for the plurality of pixels in the intermediate map comprises: for each pixel of a set of pixels of the plurality of pixels in the intermediate map, generating a value for the pixel that is greater than or lower than a value associated with the corresponding pixel in the radar-based map; generating a binary map based on the intermediate map, the binary map comprising a plurality of pixels corresponding to the plurality of pixels in the intermediate map, wherein the operation of generating the binary map comprises, for each pixel in the plurality of pixels of the binary map, computing a value for the pixel to a first value or a second value based upon a value of the corresponding pixel in the intermediate map; and outputting the binary map, the binary map comprising information usable for identifying one or more targets in the environment.

Example 17 is the non-transitory computer-readable medium of example 16, wherein the operation of generating the binary map based upon the intermediate map comprises applying a constant false alarm rate (CFAR) algorithm to the intermediate map to generate the binary map.

Example 18 is the non-transitory computer-readable medium of example 16, wherein the first value is zero and the second value is one.

Example 19 is the non-transitory computer-readable medium of example 16, wherein the operation of generating the intermediate map comprises using a trained machine-learning model that is a trained convolutional neural network (CNN) comprising (i) an input layer, (ii) a first convolution layer, (iii) a second convolution layer, and (iv) an output convolution layer, and wherein a number of model parameters for the trained CNN is less than 100.

Example 20 is the non-transitory computer-readable medium of example 16, wherein the operations further comprise training a machine-learning model to generate the trained machine-learning model, wherein the operation of training the machine-learning model comprises: detecting an environmental map using a set of sensors, wherein the set of sensors comprises more than one type of position sensor; generating a ground truth map based on the environmental map and by annotating, for each target indicated by the environmental map, (i) a velocity, (ii) a range, and (iii) a position of the target; and inputting the environmental map and the ground truth map into the machine-learning model to train the machine-learning model.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method comprising:
receiving a radar-based map of an environment surrounding a vehicle, the radar-based map comprising a plurality of pixels, each pixel of the plurality of pixels having an associated value from a range of values;
generating an intermediate map from the radar-based map, the intermediate map comprising a plurality of pixels corresponding to the plurality of pixels in the radar-based map, wherein generating the intermediate map comprises generating a plurality of values for the plurality of pixels in the intermediate map based upon values of the corresponding pixels in the radar-based map, and wherein generating the plurality of pixels values for the plurality of pixels in the intermediate map comprises:
for each pixel of a set of pixels of the plurality of pixels in the intermediate map, generating a value for the pixel that is greater than or lower than a value associated with the corresponding pixel in the radar-based map;
generating a binary map based on the intermediate map, the binary map comprising a plurality of pixels corresponding to the plurality of pixels in the intermediate map, wherein generating the binary map comprises, for each pixel in the plurality of pixels of the binary map, computing a value for the pixel to a first value or a second value based upon a value of the corresponding pixel in the intermediate map; and
outputting the binary map, the binary map comprising information usable for identifying one or more targets in the environment.

2. The method of claim 1, wherein generating the intermediate map comprises:
using a machine-learning (ML) model to generate a first map from the radar-based map, the first map comprising a plurality of pixels corresponding to the plurality of pixels in the radar-based map, wherein using the ML model comprises:
generating a plurality of values for the plurality of pixels in the first map based upon values of the corresponding pixels in the radar-based map, wherein generating the plurality of pixels values for the plurality of pixels in the first map comprises:
for each pixel of a set of pixels of the plurality of pixels in the first map, generating a value for the pixel that is greater than or lower than a value associated with the corresponding pixel in the radar-based map.

3. The method of claim 2, wherein generating the intermediate map further comprises generating the intermediate map from the first map by performing a de-normalization operation on the first map.

4. The method of claim 1, further comprising identifying one or more targets in the environment using the binary map.

5. The method of claim 1, wherein generating the binary map based upon the intermediate map comprises applying a constant false alarm rate (CFAR) algorithm to the intermediate map to generate the binary map.

6. The method of claim 1 wherein the first value is zero and the second value is one.

7. The method of claim 1, wherein generating the intermediate map comprises using a trained machine-learning model that is a trained convolutional neural network (CNN) comprising (i) an input layer, (ii) a first convolution layer, (iii) a second convolution layer, and (iv) an output convolution layer, and wherein a number of model parameters for the trained CNN is less than 100.

8. The method of claim 7, wherein the output convolution layer comprises a sigmoid activation function that generates a sigmoid output, and wherein the method further comprises applying an adaptive threshold value to the intermediate map to determine the first value and/or the second value for the corresponding pixel.

9. The method of claim 1, wherein generating the binary map comprises, for each pixel of the set of pixels of the plurality of pixels in the intermediate map:
generating and associating the first value with the pixel if a value associated with the corresponding pixel in the intermediate map is above a threshold; and
generating and associating the second value with the pixel if a value associated with the corresponding pixel in the intermediate map is less than or equal to the threshold, wherein the threshold is a hard threshold or an adaptive threshold.

10. The method of claim 1, further comprising training a machine-learning model to generate the trained machine-learning model, wherein training the machine-learning model comprises:
detecting an environmental map using a set of sensors, wherein the set of sensors comprises more than one type of position sensor;
generating a ground truth map based on the environmental map and by annotating, for each target indicated by the environmental map, (i) a velocity, (ii) a range, and (iii) a position of the target; and
inputting the environmental map and the ground truth map into the machine-learning model to train the machine-learning model.

11. The method of claim 1, wherein the radar-based map is used to generate a point cloud that represents an environment surrounding a vehicle in motion, the method further comprising:
detecting a first target in the environment using the binary map and the point cloud; and
responsive to detecting the first target, altering, based on spatial information included in the point cloud, a trajectory of motion of the vehicle to avoid a collision with the first target.

12. A system comprising:
one or more radar sensors configured to output a radar-based map of an environment, the radar-based map comprising a plurality of pixels, each pixel in the plurality of pixels, each pixel of the plurality of pixels having an associated value from a range of values;
one or more processors configured to perform processing comprising:
receiving a radar-based map of an environment surrounding a vehicle, the radar-based map comprising a plurality of pixels, each pixel of the plurality of pixels having an associated value from a range of values;
generating an intermediate map from the radar-based map, the intermediate map comprising a plurality of pixels corresponding to the plurality of pixels in the radar-based map, wherein the operation of generating the intermediate map comprises generating a plurality of values for the plurality of pixels in the intermediate map based upon values of the corresponding pixels in the radar-based map, and wherein the operation of generating the plurality of pixels values for the plurality of pixels in the intermediate map comprises:
for each pixel of a set of pixels of the plurality of pixels in the intermediate map, generating a value for the pixel that is greater than or lower than a value associated with the corresponding pixel in the radar-based map;
generating a binary map based on the intermediate map, the binary map comprising a plurality of pixels corresponding to the plurality of pixels in the intermediate map, wherein the operation of generating the binary map comprises, for each pixel in the plurality of pixels of the binary map, computing a value for the pixel to a first value or a second value based upon a value of the corresponding pixel in the intermediate map; and
outputting the binary map, the binary map comprising information usable for identifying one or more targets in the environment.

13. The system of claim 12, wherein the operation of generating the intermediate map comprises:
using a machine-learning (ML) model to generate a first map from the radar-based map, the first map comprising a plurality of pixels corresponding to the plurality of pixels in the radar-based map, wherein the operation of using the ML model comprises:
generating a plurality of values for the plurality of pixels in the first map based upon values of the corresponding pixels in the radar-based map, wherein the operation of generating the plurality of pixels values for the plurality of pixels in the first map comprises:
for each pixel of a set of pixels of the plurality of pixels in the first map, generating a value for the pixel that is greater than or lower than a value associated with the corresponding pixel in the radar-based map.

14. The system of claim 13, wherein the operation of generating the intermediate map further comprises generating the intermediate map from the first map by performing a de-normalization operation on the first map.

15. The system of claim 12, wherein the operations further comprise identifying one or more targets in the environment using the binary map.

16. A non-transitory computer-readable medium comprising instructions executable by one or more processors to cause the one or more processors to perform operations comprising:
receiving a radar-based map of an environment surrounding a vehicle, the radar-based map comprising a plurality of pixels, each pixel of the plurality of pixels having an associated value from a range of values;
generating an intermediate map from the radar-based map, the intermediate map comprising a plurality of pixels corresponding to the plurality of pixels in the radar-based map, wherein the operation of generating the intermediate map comprises generating a plurality of values for the plurality of pixels in the intermediate map based upon values of the corresponding pixels in the radar-based map, and wherein the operation of generating the plurality of pixels values for the plurality of pixels in the intermediate map comprises:
for each pixel of a set of pixels of the plurality of pixels in the intermediate map, generating a value for the pixel that is greater than or lower than a value associated with the corresponding pixel in the radar-based map;
generating a binary map based on the intermediate map, the binary map comprising a plurality of pixels corresponding to the plurality of pixels in the intermediate map, wherein the operation of generating the binary map comprises, for each pixel in the plurality of pixels of the binary map, computing a value for the pixel to a first value or a second value based upon a value of the corresponding pixel in the intermediate map; and
outputting the binary map, the binary map comprising information usable for identifying one or more targets in the environment.

17. The non-transitory computer-readable medium of claim 16, wherein the operation of generating the binary map based upon the intermediate map comprises applying a constant false alarm rate (CFAR) algorithm to the intermediate map to generate the binary map.

18. The non-transitory computer-readable medium of claim 16, wherein the first value is zero and the second value is one.

19. The non-transitory computer-readable medium of claim 16, wherein the operation of generating the intermediate map comprises using a trained machine-learning model that is a trained convolutional neural network (CNN) comprising (i) an input layer, (ii) a first convolution layer, (iii) a second convolution layer, and (iv) an output convolution layer, and wherein a number of model parameters for the trained CNN is less than 100.

20. The non-transitory computer-readable medium of claim 16, wherein the operations further comprise training a machine-learning model to generate the trained machine-learning model, wherein the operation of training the machine-learning model comprises:
detecting an environmental map using a set of sensors, wherein the set of sensors comprises more than one type of position sensor;
generating a ground truth map based on the environmental map and by annotating, for each target indicated by the environmental map, (i) a velocity, (ii) a range, and (iii) a position of the target; and
inputting the environmental map and the ground truth map into the machine-learning model to train the machine-learning model.
